(19) United States
(12) Patent Application Publication
(10) Pub. No.: US 2003/0078875 A1
(43) Pub. Date: Apr. 24, 2003

(54) Microlicensing system and method

(76) Inventors: Tim Moore, Cremorne (AU); Chris Zwolinski, Clontarf (AU); Richard Harris, Oatlands (AU); Ben Spencer, Beecroft (AU)

Correspondence Address: STETINA BRUNDA GARRED & BRUCKER, 75 ENTERPRISE, SUITE 250, ALISO VIEJO, CA, 92656, US

(21) Appl. No.: 10/258,317

(22) PCT Filed: Apr. 20, 2001
(86) PCT No.: PCT/AU01/00455

(51) Int. Cl. G06F 17/60

(52) U.S. Cl. 705/37

(57) ABSTRACT

A microlicensing system comprising: (a) a searchable database of licensable data elements; (b) search and select means which allows a user to select an individual one of said data elements according to criteria set by said user, (c) means for setting terms and conditions for use of said individual one of said data elements so as to define an identifiable transaction; (d) means for transmission of said individual one of said data elements to a user device; said user device enabling usage of said individual one of said data elements.

The present invention relates to a microlicensing system and method and, more particularly, to such a system and method adapted, although not exclusively, for the dissemination of copyright-protected works such as pictures and moving pictures with or without associated audio content.

### BACKGROUND

Licensing, particularly involving copyright works has, previously, involved a convoluted and time-delayed arrangement for distributing payments consequential to the creation and/or use of works, whether by way of royalties, licence fees or otherwise.

Furthermore, due to perceived difficulties in being able to meter accurately the usage of works, there are various bulk payment schemes in operation which rely on an estimate (sometimes an extremely coarse estimate) of use of the work. Such arrangements may not be considered fair to all parties.

It is an object of the present invention to address or ameliorate one or more of the above-mentioned disadvantages.

### BRIEF DESCRIPTION OF INVENTION

Accordingly, in one broad form of the invention there is provided a microlicensing system comprising:

(a) a searchable database of licensable data elements;

(b) search and select means which allows a user to select an individual one of said data elements according to criteria set by said user;

(c) means for setting terms and conditions for use of said individual one of said data elements so as to define an identifiable transaction;

(d) means for transmission of said individual one of said data elements to a user device; said user device enabling usage of said individual one of said data elements.

Preferably said data element includes a licensable component comprising an image component.

Preferably said data element includes associated primary data.

Preferably said data element includes associated transaction-specific data.

Preferably said primary data includes author identity, model identity and agent identity information.

Preferably said associated transaction-specific data includes license terms, license constraints and financial data.

Preferably said system further includes a pay trigger.

Preferably said pay trigger causes calculation of payments at substantially the same time for all stakeholders identified by said system as party to said identifiable transaction.

Preferably said searchable database incorporates a microprocessor and memory.

Preferably said system further includes an encapsulation device for encoding of at least portions of said desired one of said data elements.

Preferably said system further includes decoding software.

Preferably said decoding software is implemented as a shell program.

Preferably said search and select means incorporates a dynamic tagging means.

Preferably said dynamic tagging means comprises a dynamic tagging device.

Preferably said dynamic tagging device logs customer data including customer route data.

Preferably said payment to stakeholders and the identity of stakeholders is a function of said payment route data.

Preferably said search and select means incorporates dynamic filter means.

Preferably said dynamic filter means permits browsing of at least the licensable portions of said data elements according to predetermined filter criteria.

Preferably said predetermined filter criteria include one or more of geographic origin of prospective user, area of commercial endeavour in which said prospective user operates.

Preferably said system incorporates a dynamic pay map means by which payments to all of the individual ones of said stakeholders are determined.

Preferably said dynamic pay map means determines payments as a function of at least a first variable and a second variable.

Preferably said first variable comprises transaction route and said second variable comprises stakeholder identity.

Preferably said second variable is comprised of a constant grouping and a variable grouping.

Preferably said constant grouping comprises a constant stakeholder grouping.

Preferably said variable grouping comprises a variable stakeholder grouping.

Preferably said dynamic pay map means determines payments as a function of at least a first variable and a second variable.

Preferably said variables are dynamically allocated by one or more of said dynamic tagging device and said dynamic filter device.

In a further broad form of the invention there is provided a method of microlicensing works for the benefit of all of the individual ones of a plurality of stakeholders; said method comprising utilising a microlicensing system comprising:

(a) a searchable database of licensable data elements;

(b) search and select means which allows a user to select an individual one of said data elements according to criteria set by said user;

(c) means for setting terms and conditions for use of said individual one of said data elements so as to define an identifiable transaction;

(d) means for transmission of said individual one of said data elements to a user device; said user device enabling usage of said individual one of said data elements.

In yet a further broad form of the invention there is provided a method of calculation of payments to stakeholders; said method comprising calculating according to a pay map the return due to all of the individual ones of said stakeholders at the one time.

### BRIEF DESCRIPTION OF DRAWINGS

Embodiments of the invention will now be described with reference to the accompanying drawings wherein:

FIG. 1 is a block diagram of the creation of a work and its incorporation into a searchable database of licensable data elements according to a first embodiment of the invention;

FIG. 2 is a block diagram of a microlicensing system according to a further embodiment of the invention utilising the database of FIG. 1;

FIG. 3 is a flowchart of usage of the system of FIG. 2;

FIG. 4 is a block diagram of a microlicensing system having enhanced security according to a further embodiment of the invention also utilising the database of FIG. 1;

FIG. 5 is a flowchart of usage of the system of FIG. 4;

FIG. 6 is a block diagram of a security system adapted to secure works when used with the system of FIG. 4;

FIG. 7 is a block diagram of a microlicensing system according to a further embodiment of the invention and utilising modifications to the database of FIG. 1;

FIG. 8A is a block diagram of steps in the implementation of the system of FIG. 7 incorporating dynamic tagging;

FIG. 8B is a block diagram of operation of a dynamic filter in association with the system of FIG. 7.

FIG. 9 is a block diagram of details of a pay map utilised in accordance with the embodiment of FIG. 7;

FIGS. 10 to 22 illustrate an example of an implementation of a searchable database of licensable data elements implementing a microlicensing system according to one or more of the embodiments previously described;

FIG. 23 is a block diagram of a database structure incorporating an internet interface according to a further embodiment of the invention;

FIG. 24 is a block diagram of the data element structure and relevant functional modules for use in conjunction with the system of FIG. 23;

FIG. 25 is a diagrammatic representation of a dynamic pay map structure for use in conjunction with the system of FIG. 23;

FIG. 26 is a graphical representation of the interrelationship between parameters which affect operation of the dynamic pay map of FIG. 25;

FIG. 27 is an intranet image search screen according to a fourth preferred embodiment of the present invention;

FIG. 28 illustrates an intranet search result screen;

FIG. 29 illustrates a catalogue record screen;

FIG. 30 illustrates an Internet search screen;

FIG. 31 illustrates a search results screen via an intranet;

FIG. 32 illustrates an order record screen;

FIG. 33 illustrates an order record screen;

FIG. 34 illustrates an order record screen;

FIG. 35 illustrates a further order record screen of the system of FIG. 27;

FIG. 36 illustrates a further intranet order screen;

FIG. 37 illustrates a further intranet order screen;

FIG. 38 illustrates an Inter net order screen;

FIG. 39 illustrates an Internet media/usage builder screen;

FIG. 40 illustrates an Internet license dynamic price builder screen;

FIG. 41 illustrates an Internet order screen with license attached;

FIG. 42 illustrates an Internet order confirmation page screen;

FIG. 43 illustrates a license terms screen;

FIG. 44 illustrates an order purchase screen with download selection;

FIG. 45 illustrates combined image and license details data;

FIG. 46 illustrates combined image and license data in a fulfilled order;

FIG. 47 illustrates a customer record data;

FIG. 48 illustrates bureau summary data;

FIG. 49 illustrates bureau summary data;

FIG. 50 illustrates bureau summary data;

FIG. 51 illustrates bureau summary data in accordance with the fourth embodiment of the present invention;

FIG. 52 illustrates further bureau summary data;

FIG. 53 illustrates further bureau summary data;

FIG. 54 illustrates further bureau summary data;

FIG. 55 is a diagrammatic representation of the parallel calculate and pay system according to a fourth embodiment of the present invention.

FIG. 56 illustrates a distributed restriction system.

### DETAILED DESCRIPTION OF PREFERRED EMBODIMENTS

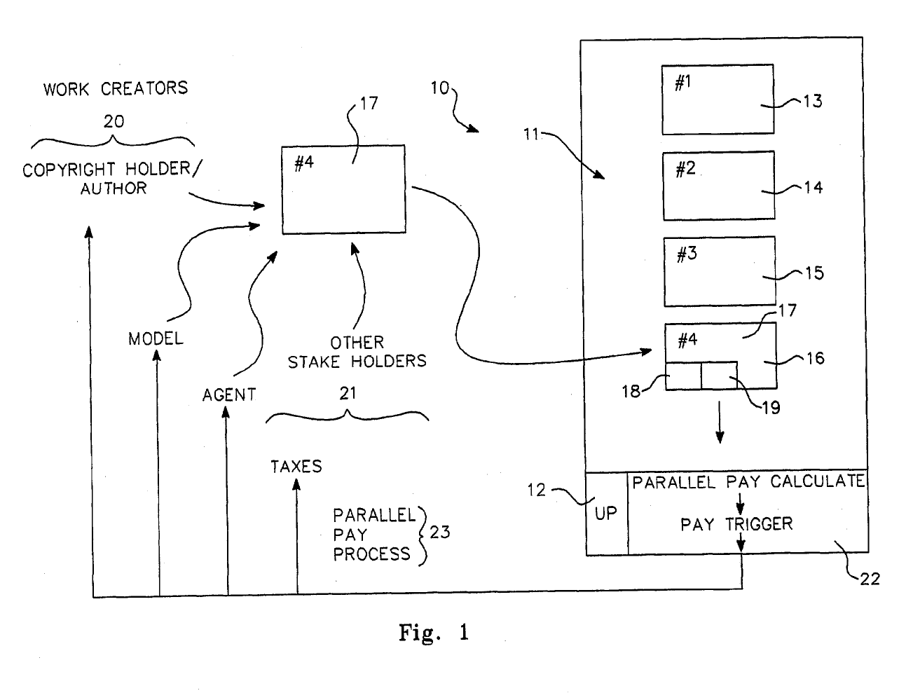

With reference to FIG. 1 there is illustrated a microlicensing system 10 comprising a searchable database 11 operable in conjunction with microprocessor and memory 12.

The searchable database 11 includes, in this instance, first data element 13, second data element 14, third data element 15 and fourth data element 16.

More particularly, in this instance, each data element 13, 14, 15, 16 comprises a licensable component in the form of a digital image component 17 in conjunction with at least an associated primary data component 18 and, optionally, an associated transaction-specific data component 19.

With further reference to FIG. 1, and by way of example, fourth data element 16 comprises a licensable component in the form of, in this instance, digital image 17 saved in database 11. In this instance, the element 16 also includes an associated primary data component 18 and an associated transaction specific component 19.

The image component 17 is a copyright work (that is, a work protectable under Copyright law in many jurisdictions) created by work creators 20 comprising, in this instance, a copyright holder/author, a model (the subject of the work) and an agent. Also associated with image component 17 are other stakeholders 21 comprising, in this instance, collecting agencies including tax collecting agencies.

In this particular implementation of microlicensing system 10 the database 11 is collated, organised and driven by microprocessor and memory 12. In particular this combination allows a user (not shown) to browse at least the licensable component of the data elements 13, 14, 15, 16 including, in this instance, digital images one or more of which the user may require for a specific application and for a limited period of use.

The user, having selected an image for use (licensing) can then make use of the image in return for payment for the use on agreed terms. Usage according to the agreed terms triggers a liability for payment to the stakeholders in the form of pay trigger 22 which initiates parallel pay process 23 whereby the work creators 20 and the other stakeholders 21 all have calculated together (in parallel) the appropriate payment due to each resulting from the permitted use of the copyright work, in this instance image 17.

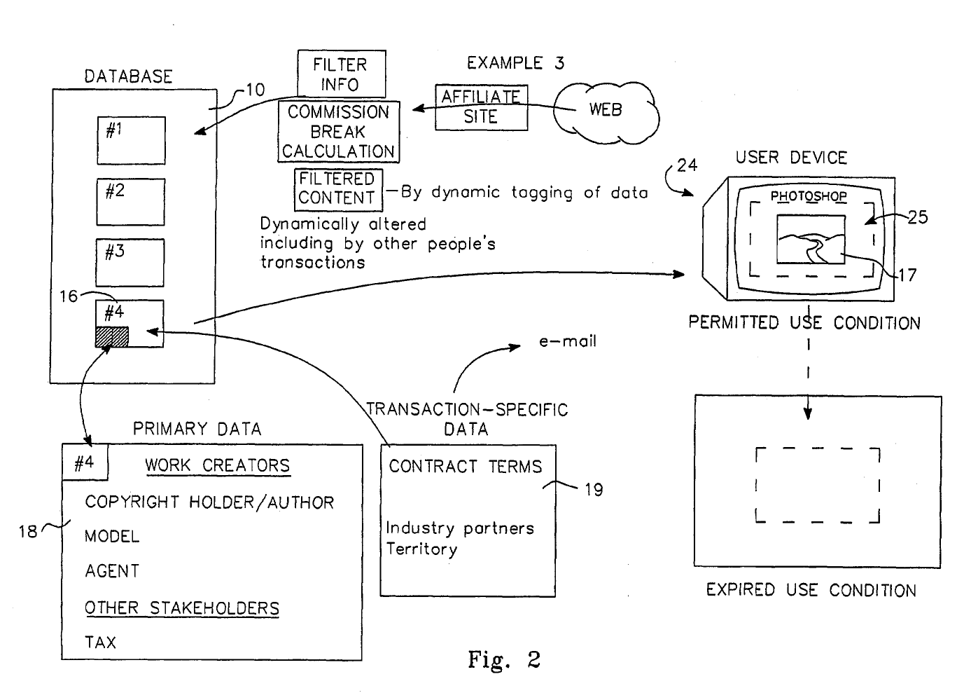

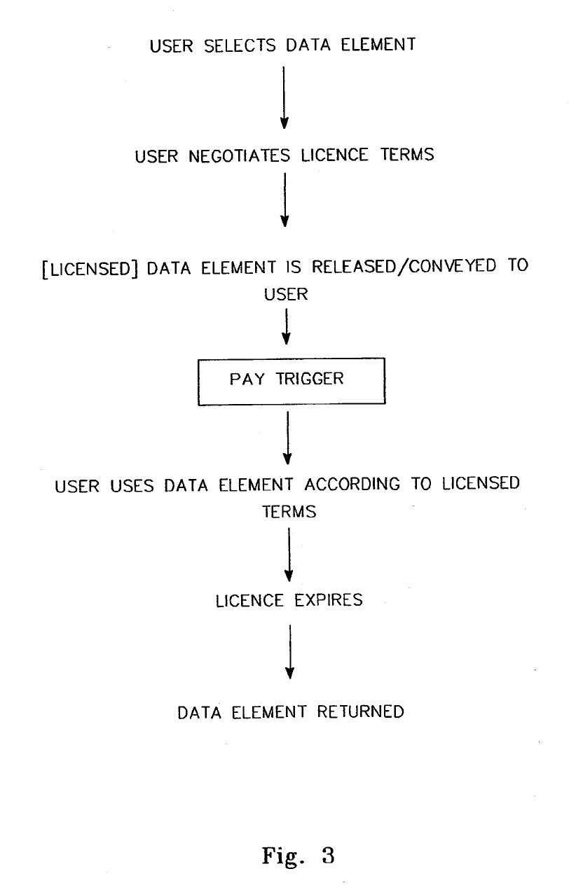

With particular reference to FIGS. 2 and 3 a particular manner of usage of the image component 17 driven and controlled by microlicensing system 10 will be described as a first preferred embodiment.

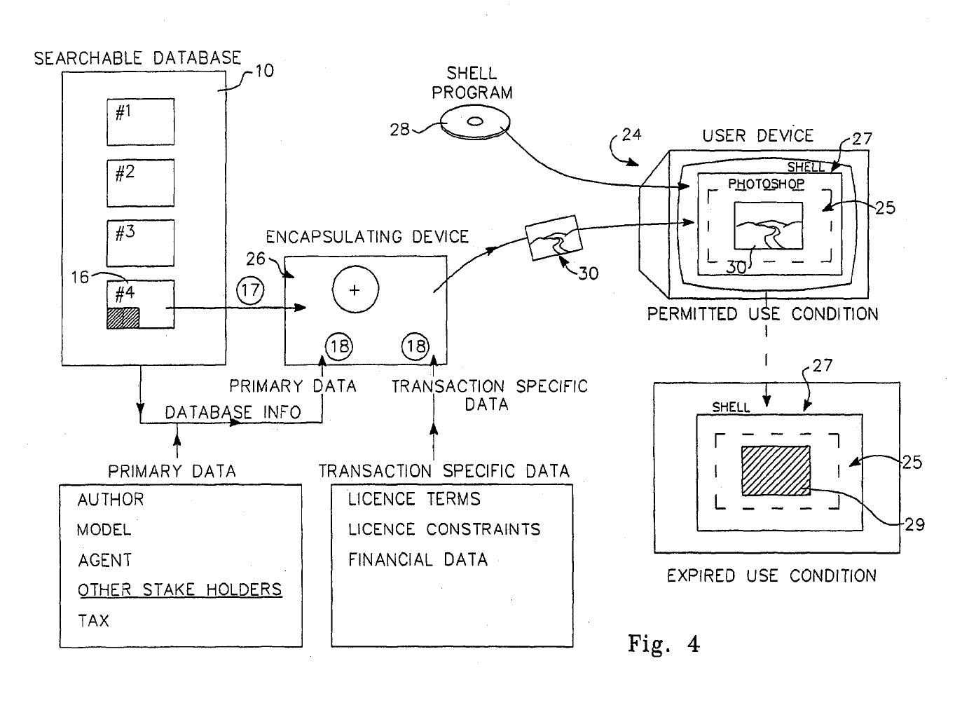

With reference to FIGS. 4, 5 and 6 a variation on the usage control driven by microlicensing system 10 and incorporating additional security and control features will be described as a second preferred embodiment.

1. First Preferred Embodiment

With particular reference to FIG. 2 and FIG. 3 database 10 can be caused to transmit image 17 of fourth data element 16 as a result of agreed contract terms in the form of associated transaction-specific data 19.

The transmission, in this instance, is of only image component 17 to user device 24 which, in this instance, comprises a computer and printer combination running an image manipulation program 25, in this instance the commercially available package known as PHOTOSHOP. The image 17 can be transmitted over commonly available communication channels by electronic or fibre optic means and can be via the Internet or by means of a direct connection or Intranet connection.

Optionally, although in this instance not required, associated transaction-specific data 19 relating to licensing and usage parameters can be transmitted as part of fourth data element 16 to user device 24.

The user (not shown) may then manipulate image component 17 using manipulation program 25 in accordance with the licensed terms as defined by contract terms 19. At the time of entering into the licence agreement or at the commencement of use or when the license expires or at another predetermined point a pay trigger 22 causes microlicensing system 10 to first calculate at the same time for all of the individual ones of the stakeholders identified for that transaction and then to pay automatically the appropriate royalty or other return due to the stakeholders of image component 17 including, but not limited to, the work creators 20 and other stakeholders 21 as described earlier with reference to FIG. 1. FIG. 3 illustrates a flowchart of the process of the first embodiment. The steps of the process can also be described as follows:

Step 1A

Photograph 17 Supply Account opened

Photograph is catalogued, barcoded and scanned

Customer Account opened.

Step 1B

Customer searches archive or database 10 by one or more of subject, keyword, description and intended usage profile.

Search results can exclude industry, censorship, and photographer, and territory restrictions.

Step 1C

Customer requests quote which is built by a group of parameters

Media (printrun, size, position)

Territory

Period of Use

Industry of Use

Customer may request competitive restriction control by industry, territory and time.

Analogue or digital photographs are delivered.

Step 1D

Customer uses photo or image portion 17 as per license parameter details and returns original analogue versions.

Invoice is processed as per license.

Receipt is collected (unless credits occur).

Step 1E

Following receipting the various stakeholders or interested parties including

Agents/Distributors

Affiliates

Photographers

Models

Withholding Tax/GST

are paid in a parallel pay process 23.

2. Second Preferred Embodiment

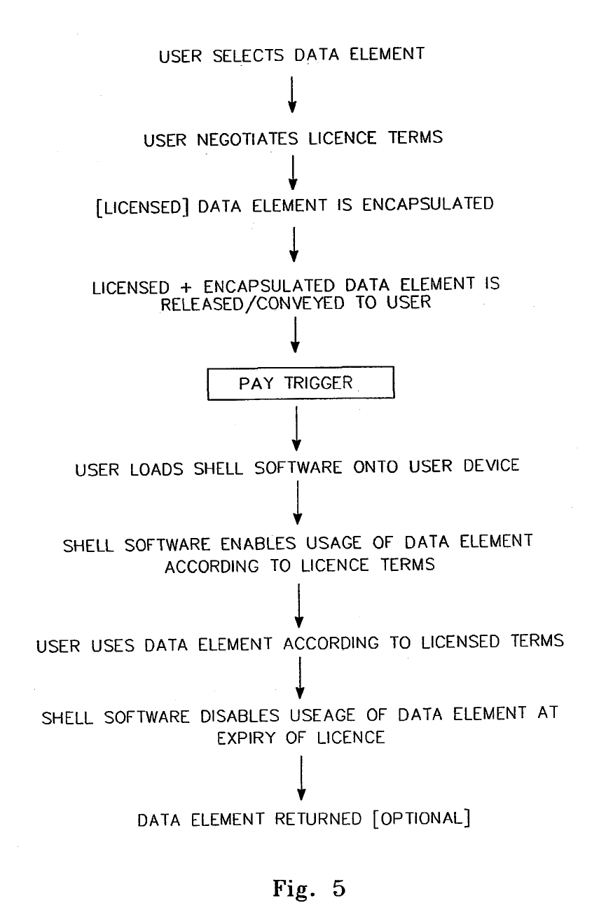

With reference to FIGS. 4 and 5 a modification to the process of the first embodiment will be described where like components are numbered as for the first embodiment.

In this embodiment a security measure is implemented in the form of encapsulation device 26 which, following the example of the first embodiment, combines image component 17, associated primary data 18 and associated transaction specific data 19 of fourth data element 16 into an encapsulated image data element 30.

In this embodiment, in place of the (unencoded/unencapsulated image component 17) an encapsulated image data element 30 is transmitted to user device 24.

The user can only manipulate image 17 stored within encapsulated image data element 30 after having first loaded shell program 27 from CD 28.

The shell program 27 sets up an environment within which the manipulation program 25 can operate on encapsulated image data element 30 and so as to gain full access to image component 17 contained therein.

On termination of permitted use the shell program 27 causes at least image component 17 to become disabled. in the form of disabled image/data element 29.

The steps in the operation of the second embodiment are summarised in FIG. 5 and are as follows:

Step 2A

Photograph 17 Supply Account opened

Photograph is catalogued, barcoded and scanned

Customer Account opened.

Step 2B

Customer searches archive or database 10 by one or more of subject, keyword, description and intended usage profile.

Search results can exclude industry, censorship, and photographer, and territory restrictions.

Step 2C

Customer requests quote which is built by a group of parameters

Media (printrun, size, position)

Territory

Period of Use

Industry of Use

Customer may request competitive restriction control by industry, territory and time.

Analogue or digital photographs are delivered.

Step 2D

Customer uses photo or image portion 17 as per license parameter details and returns original analogue versions.

Invoice is processed as per license.

Receipt is collected (unless credits occur).

Step 2D1

Once the photo 17 is ready for delivery in digital form the licence parameters in the form of transaction specific data 19 are embedded into the photo in a secure format.

Once the license is issued the image 17 can be taken out of the secure format until the license expiry. At the expiry date an inbuilt expiry routine destroys the image or otherwise renders it unusable.

Step 2E

Following receipting the various stakeholders or interested parties including

Agents/Distributors

Affiliates

Photographers

Models

Withholding Tax/GST

are paid in a parallel pay process 23.

In this example software operated under the control of microprocessor 12 fully automates process steps A-D. The software further enables that in Step E, all interested parties have their entitlement calculated in parallel and are paid substantially instantaneously or in parallel. That is to say stakeholders are each paid substantially at the same time.

This is a paradigm shift to current industry practice. The identifiable individual customer transaction is directly related back to each and every one of the interested parties (royalty recipients) at the same time rather than sales being accumulated in bulk. The process is then directly and instantaneously connected to interested parties for payment in parallel.

The content micro licensing and parallel royalty payment system of this embodiment can be applied to all forms of digital content (e.g. music, text, video, illustrations, artwork, photographs and software) transacted via the Internet whether cable, fibre or wireless.

3. Encapsulation System

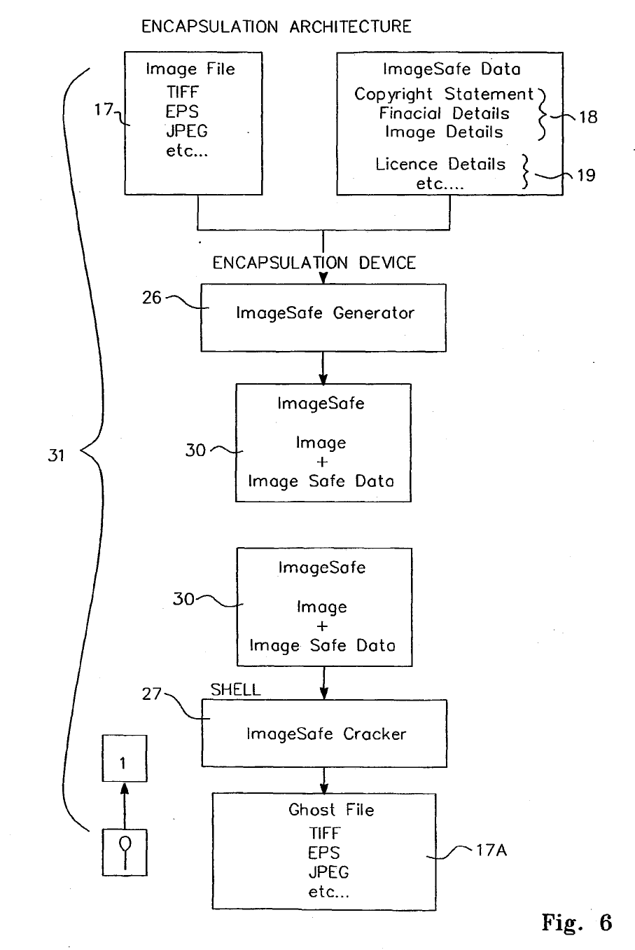

With particular reference to FIG. 6 an encapsulation system 31 is illustrated in block diagram form which further summarises the manner of operation of encapsulation device 26 (described with reference to the second preferred embodiment) and its manner of interaction with shell or shell program 27 (also described with reference to the second preferred embodiment).

3.1 Encapsulation System Key Objectives

The core objectives of the encapsulation system are as follows:

1. Provide a secure encapsulation of a digital image 17 (payload) or image in combination with other data such as fourth data element 16.

2. Enable the encapsulation of the image 17 to be configured based on dates and time frames so as to restrict the access to the image beyond a certain period (time bomb) which is related to the license terms forming part of the associated transaction-specific data.

3. Enable the encapsulation process to contain details regarding the information such as Copyright, Image Information etc.

4. Enable the application of choice to edit the image 17 without actually being able to remove the image from the encapsulation domain.

5. Enable the image 17 to be accessed on a file system by other applications for the purpose of printing/viewing the image while ever the license is valid.

6. Automatic corruption of at least the file containing the high resolution image 17 when accessed after the agreed time frame.

3.2 Overview of Architecture

The encapsulation device 26 receives image file 17, primary data 18 and transaction-specific data 19 and combines it into a separate file using coding techniques thereby to form encapsulated image data element 30. The data element 30 can be unencoded only by user programs operating within the environment of shell 27 as generally illustrated in FIG. 6.

The shell program 27 additionally includes the capability to interpret transaction-specific data so as to regulate the term of use of at least the image component 17 of encapsulated image data element 30 and otherwise generally in accordance with licensed or permitted use agreements entered into by the user with the operator of database 11.

3.3 Components in Proposed Concept

3.3.1 The Encapsulation Device

The encapsulation device 26 offers the following features:

1. The ability to embed an existing image file 17, 16 structure;

2. The ability to hold expiry related parameters;

3. The ability to hold specific licensing constraints.

4. The ability to hold specific payload information;

5. The ability to hold specific financial transaction information relevant to the image.

3.3.2 The Shell Application

The shell or Shell Application 27 offers the following features:

1. The ability to open the data file 17, 16 regardless of embedded payload.

2. The ability to display licence parameters and associated calculations.

3. The ability to display specific licensing constraints.

4. The ability to display specific payload information.

5. The ability to edit the payload by the appropriate application without allowing the file to be saved external to the shell domain.

6. Once the application has started and the appropriate data file has been unlocked the application will create an associated “Ghost File” that allows other applications to see and access for the purpose of printing and viewing (but not editing).

3.3.3 Ghost File

The GhostFile is a shortcut, alias or link to the resident image, that allows for applications such as Quark, Pagemaker etc. to link the image to the assembled page. Similarly in a preferred form a GhostFile will be compatible with the current versions of OPI solutions that are available on the Windows NT platform.

3.3.4 The ImageSafe Generator Application

The Data File Generator generates a data file. In a preferred form the generator will be a wizard and/or offer an API interface to allow batch generation of many data files.

3.4 Image Editing

Fundamental to the successful creation of the mechanism is the ability to allow the editing of an image without being able to remove the image from the shell application. While it is important to enforce the parameters of the shell application it must also be stated that it is equally important to allow the image to be edited by the application of choice. If the security is too tight and not flexible enough for the target client base the technology will not be adopted and as a result the product may affect market penetration. Applications such as Photoshop or any application that can manipulate the fundamental image formats should still be able to access the image contained within the shell application.

3.5 Key System/Platform Constraints

In this embodiment for the shell to be implemented properly it must conform to the following constraints:

1. Both the Data File Application and Generator will be able to run on Windows 95, Windows NT, Mac OS 7.1 and above.

2. Will be able to store the data file on a Windows NT server

3. Will be able to work with current OPI (Open Pre-Press Interface) solutions that run on Windows NT (Alpha and Intel).

4. Dynamic Tagging of Data

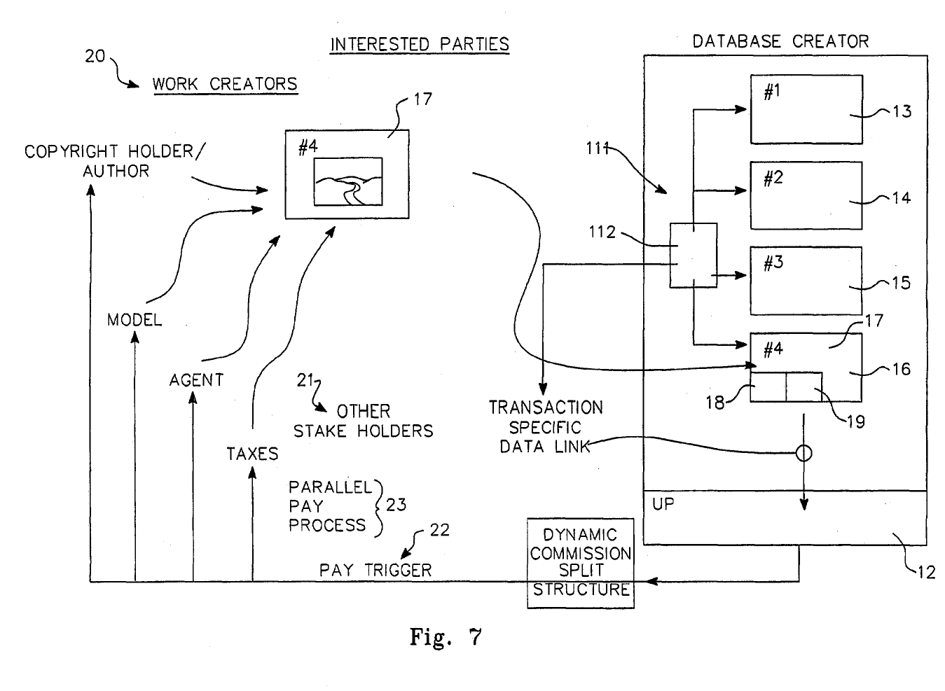

With reference to FIG. 7 the searchable database 11 previously described with reference to FIG. 1 is modified to form searchable database 111. Like components are otherwise numbered as for the database described with reference to FIG. 1.

In this instance searchable database 111 incorporates dynamic tagging device 112.

The dynamic tagging device 112 receives, logs and takes account of the source of incoming enquiries for the purpose of and so as to modify the identity of the stakeholders for any given transaction subsequently arising from the enquiry and/or to modify the quantum of payment due to the stakeholders again, as a consequence of the identity or, in some cases, the route, by which the enquiry has arrived.

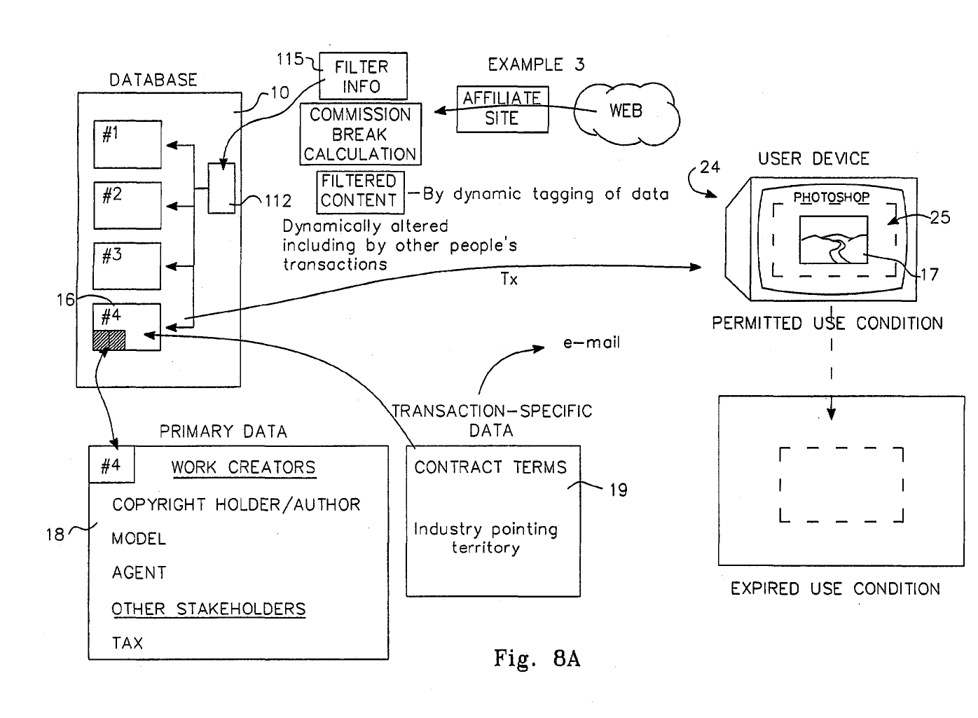

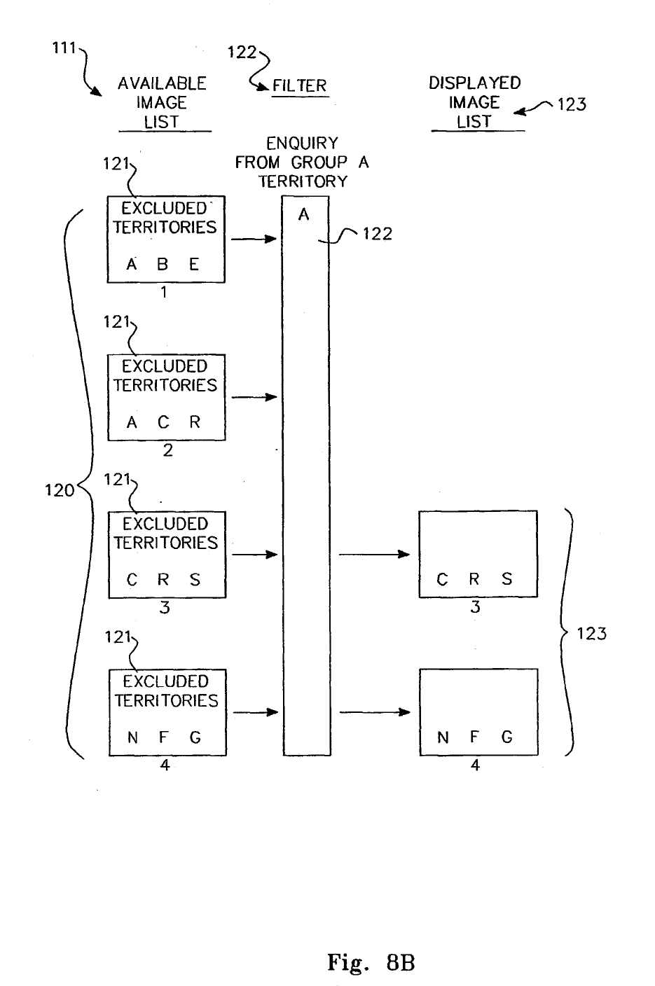

With reference to FIG. 8A a particular transaction in which the dynamic tagging device 112 is invoked can involve an enquiry via the Internet 113 and arrives as a result of an initial enquiry on an affiliate site 114, which site 114 as a result of prior agreement with the owner or operator of searchable database 111, causes the enquiry to be routed to an Internet enquiry screen 115 directly connected to and otherwise operated by the owner/operator of searchable database 111.

In this instance, because the enquiry has resulted from an enquiry initially on the affiliate site 114 the dynamic tagging device 112 will now include the sponsors of the affiliate site 114 as a stakeholder for the purpose of calculation of remuneration due to stakeholders as a result of any licensing transaction subsequently entered into based on that enquiry. The inclusion of the affiliate site 114 as a stakeholder can have an effect on the quantum of payment to others of the stakeholders and, if so, this will be taken into account by the dynamic tagging device 112.

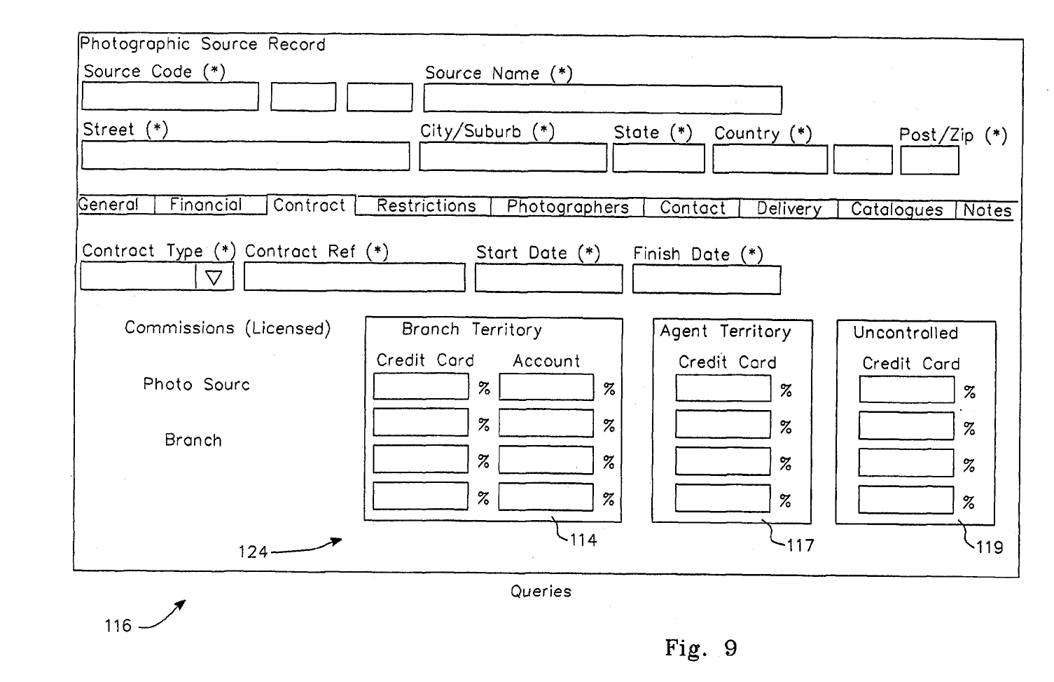

FIG. 9 illustrates a source record screen 116 for searchable database 111 which includes an “agent territory” record 117, a “branch territory” record 118 and an “uncontrolled credit card” record 119, entries into which depend upon the route by which a transaction has arrived at searchable database 111 and to the mode of payment for a transaction elected, entries into which can affect the identity of stakeholders and the quantum payable to stakeholders.

5. Dynamic Filtering of Data

With reference to FIG. 8B the searchable database 111 includes an available image list 120 comprised, in this instance, of images numbers 1, 2, 3, 4. Each image includes, in this instance, an “excluded territories” field 121 wherein territories for exclusion are identified by capital letter. So, for example, image 1 has an excluded territories field 121 comprising territories A, B, E. The dynamic filter 122 is arranged so as to permit the available image list 120 to be filtered according to a specified criteria. In this instance the filter criterion is according to excluded territories wherein, for example, if an enquiry is identified as originating from territory A then filter 122 will exclude those images which identify territory A as excluded from displayed image list 123.

Thus, in this instance, only image 3 and image 4 are permitted by filter 122 to form displayed image list 123.

It is to be understood that this function is dynamic in that if, for example, territory A is removed from the excluded territories field 121 of image 1 then image 1 will automatically become available immediately for display on displayed image list 123 following a fresh enquiry from a group A territory.

In this way images are made available from database 111 to an enquirer only if they would be available for use by the enquirer.

### EXAMPLE 1

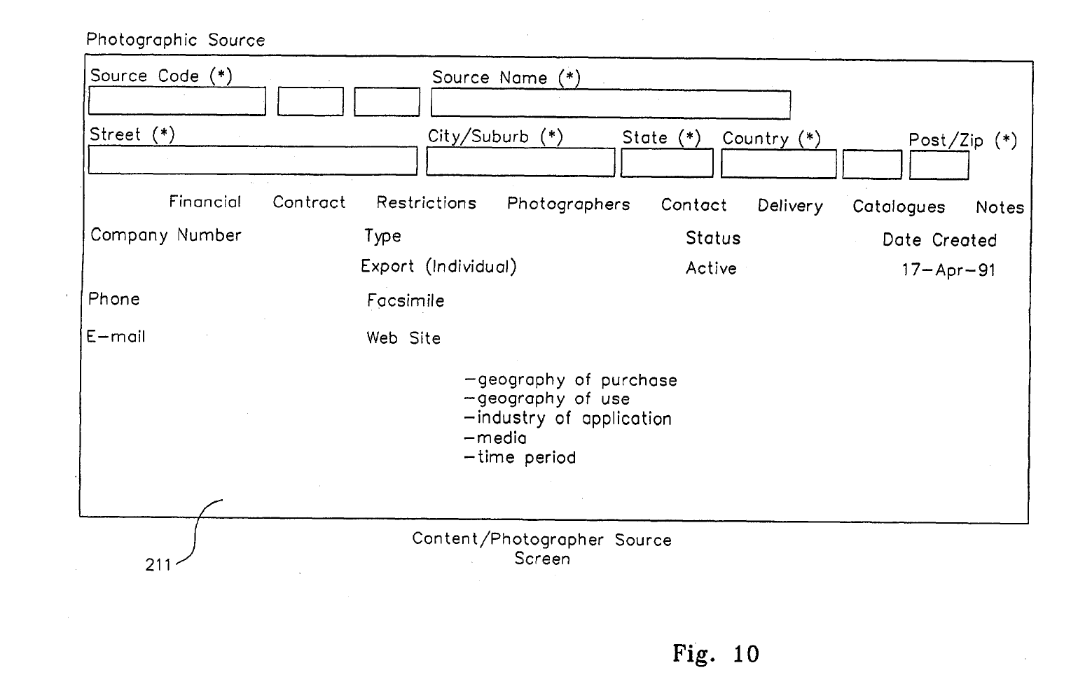

With reference to FIGS. 10 to 22 an exemplary transaction will now be described with particular reference to screens and other communication media by which an exemplary transaction 210 can be transacted.

FIG. 10 illustrates a content/photographer source screen 211.

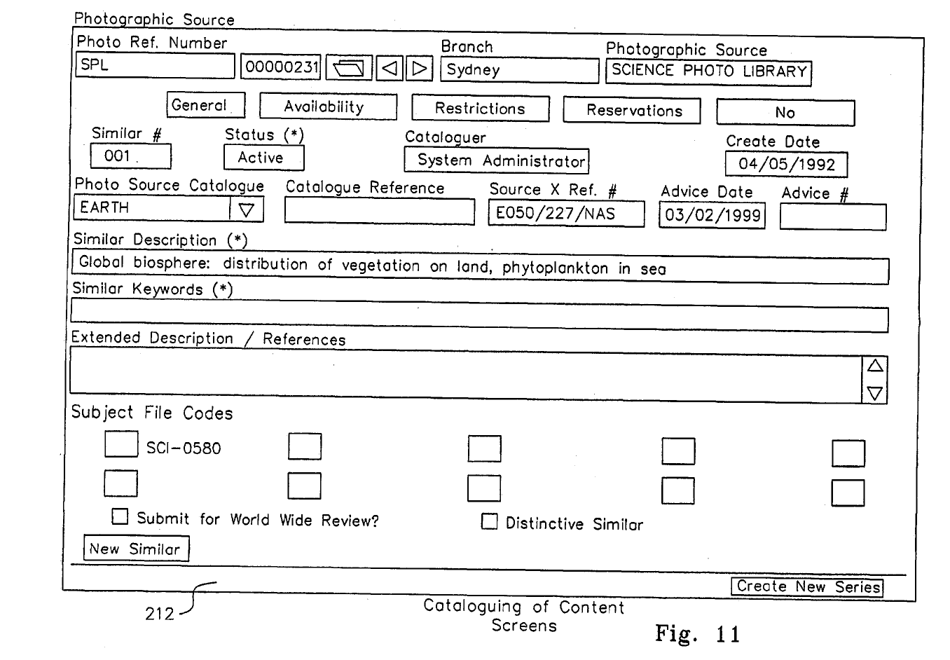

FIG. 11 illustrates a cataloguing of content screen 212.

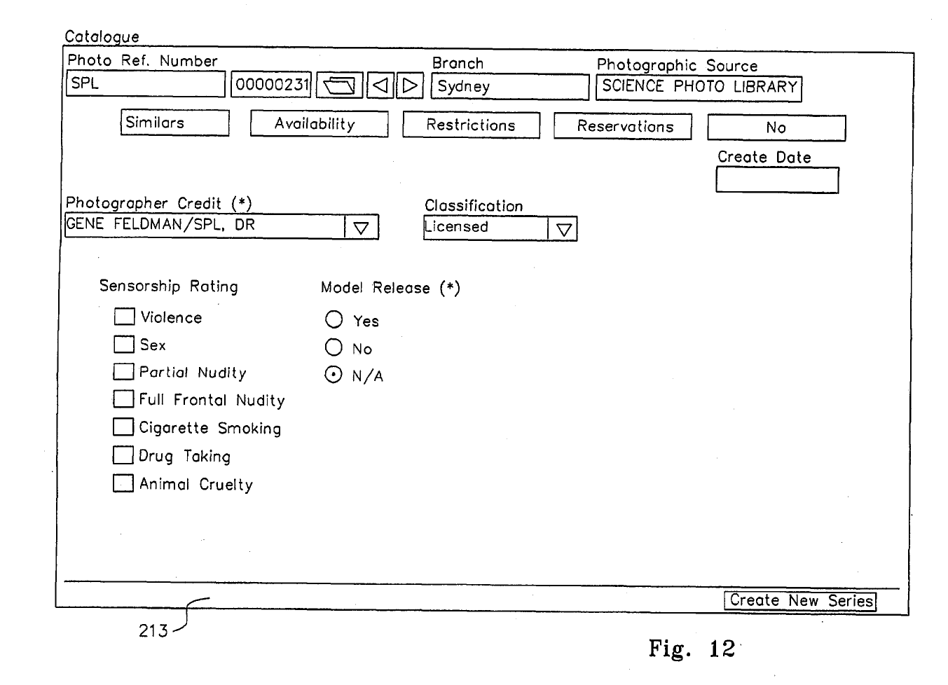

FIG. 12 illustrates a photographic source screen 213 which provides details of the source of a given work for placement on the database.

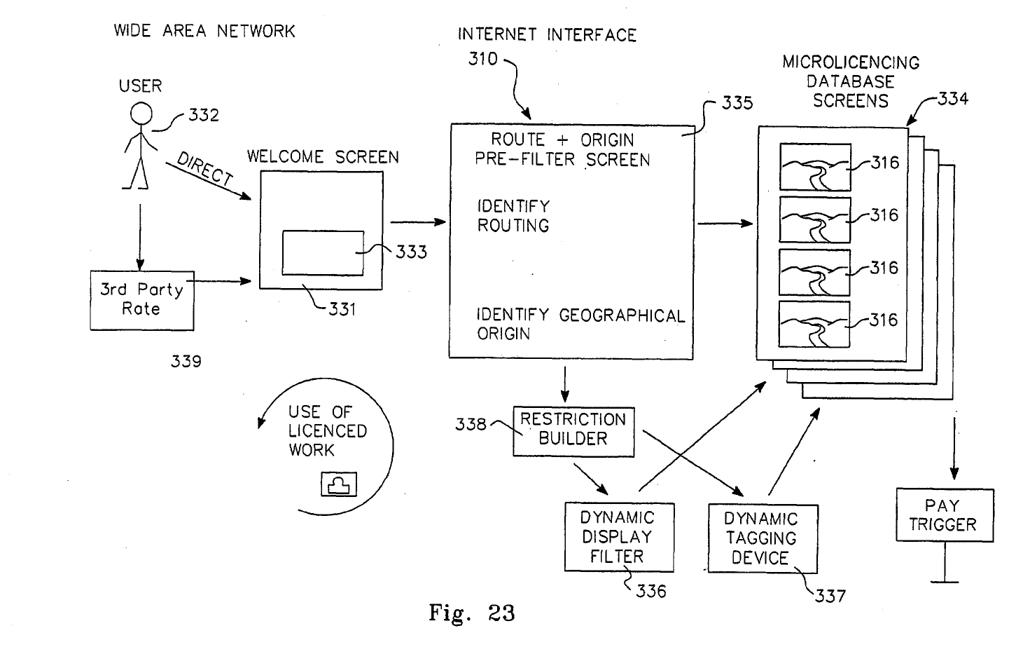

The source screen 213 additionally includes restrictions on the use of the photographic work, in this case relating to censorship rating and model release. These restrictions are monitored dynamically by the restriction builder (338 in FIG. 23) for incorporation into the dynamic tagging device and dynamic display filter.

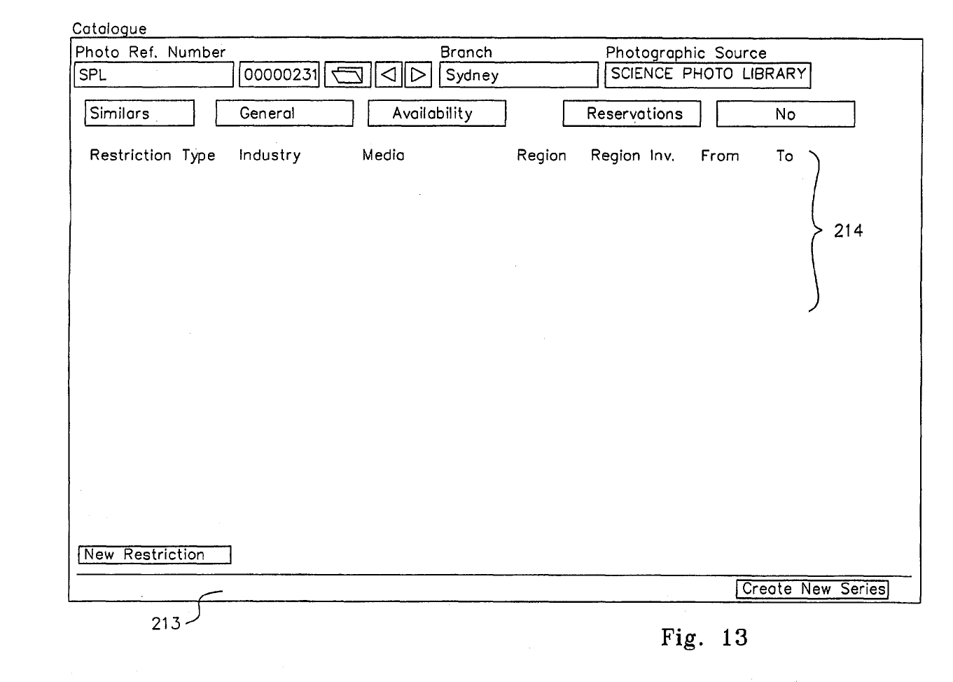

FIG. 13 illustrates a further example of a photographic source screen 213 and including a restriction listing 214 providing an example of data which can be associated with a work, either as associated primary data or as associated transaction specific data.

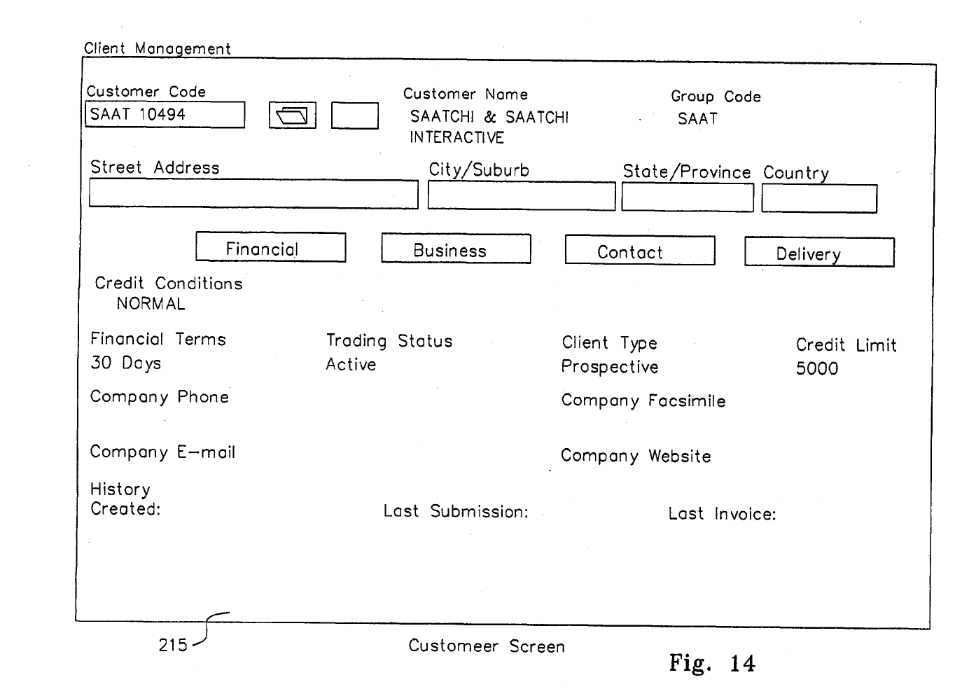

FIG. 14 illustrates a customer screen 215 setting out the nature of data typically held in respect of any given customer or prospective customer.

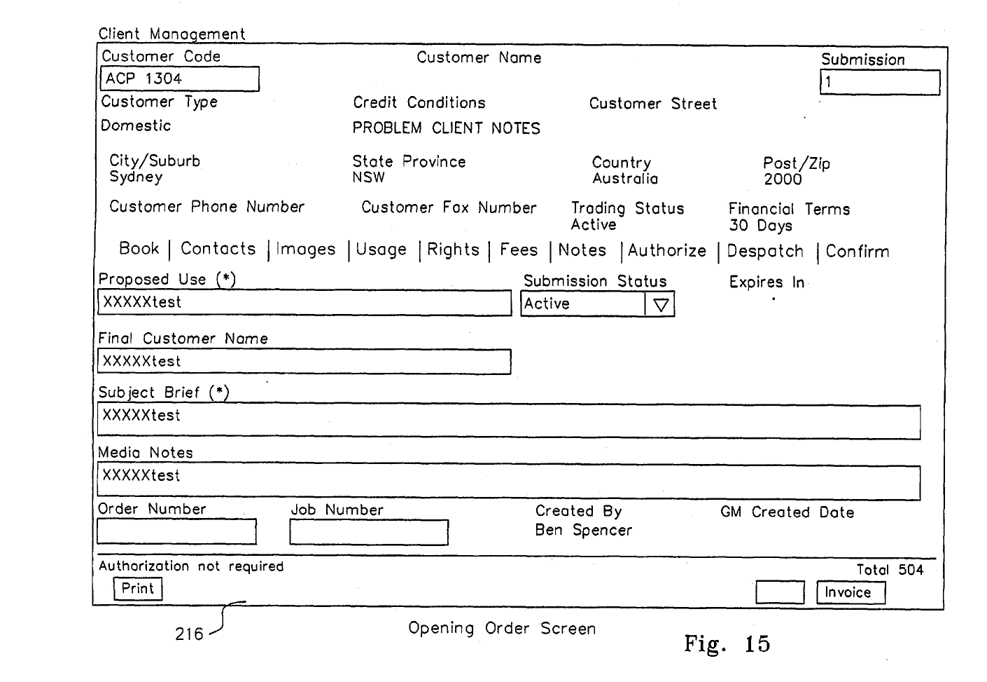

FIG. 15 illustrates an example of an “opening order screen” 216 illustrating the nature of data taken in respect of a client for storage on the database related to an order.

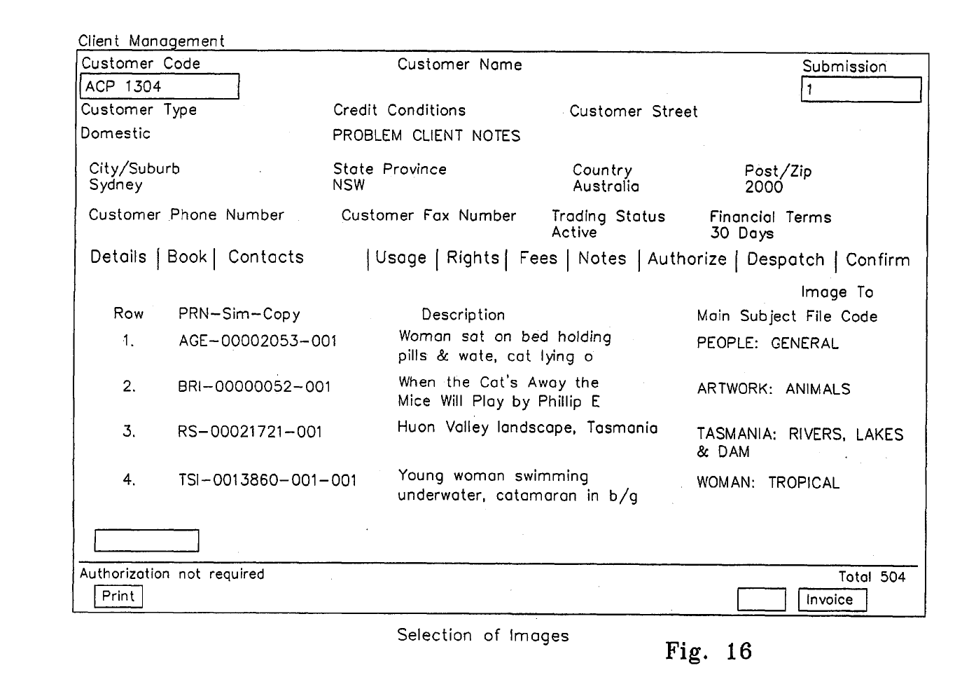

FIG. 16 illustrates typical database content comprising a selection of images 217 submitted to a user, each comprising a microlicensable work.

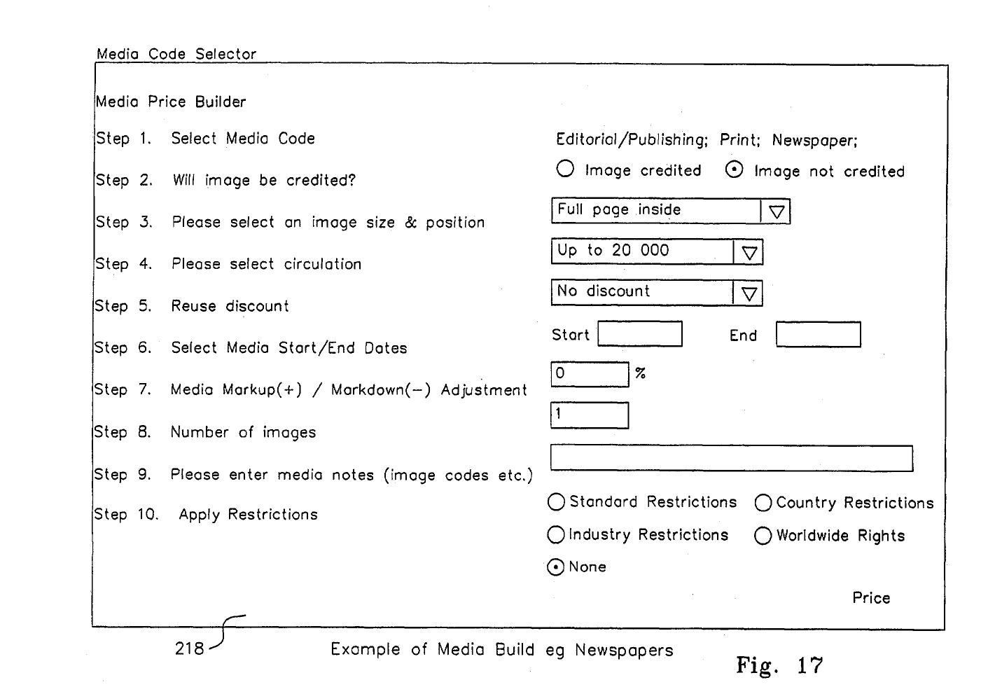

FIG. 17 illustrates an example of a media price builder 218 relating to a newspaper, data from which feeds into the pay map 124 (refer FIG. 9).

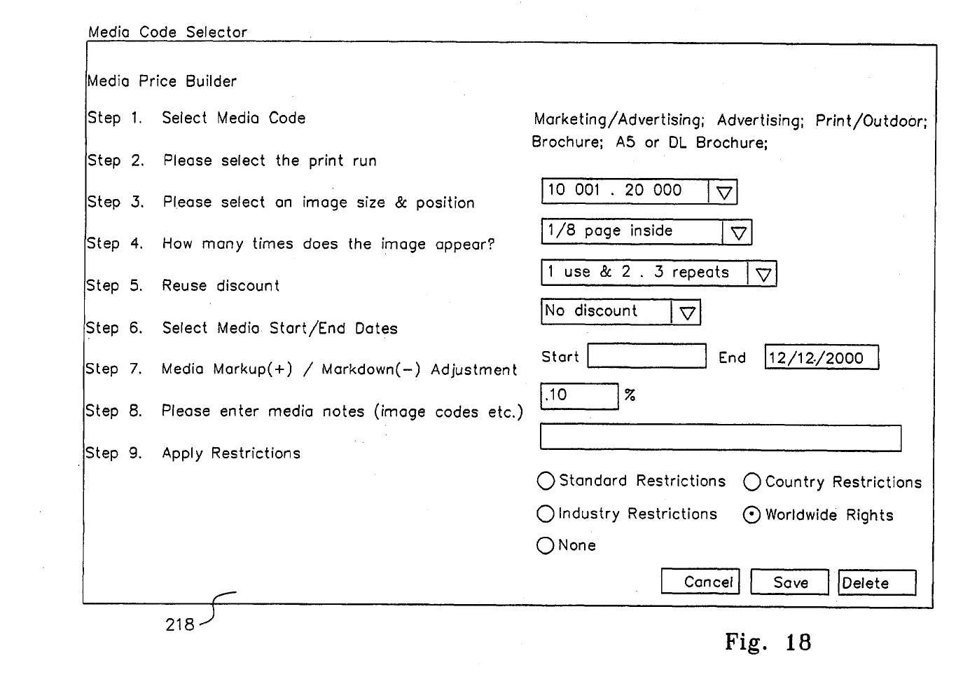

FIG. 18 is a further example of a media price builder 218, in this instance related to a brochure. Again, data devised from this screen is utilised to formulate pay map 124 as part of determining the licence terms for this transaction.

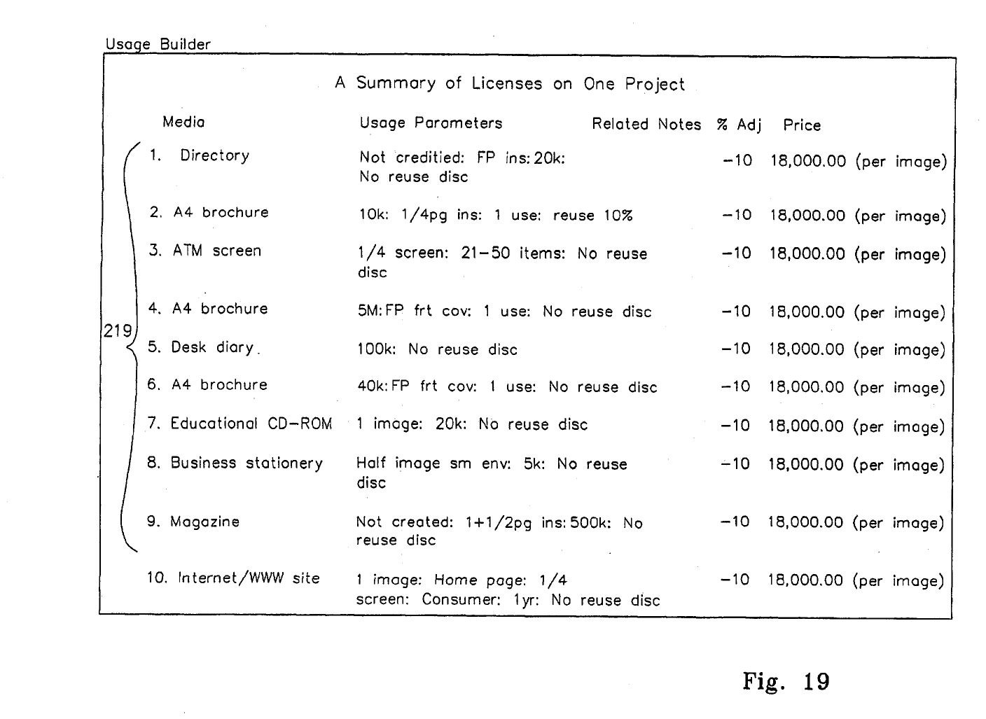

FIG. 19 is a print out of a licensed works listing 219. Each of the entries numbers 1 to 31 comprises details of a specific licensed or licensable work and providing examples of transaction specific data in respect of each licensed work, in this instance comprising media, usage parameters and price.

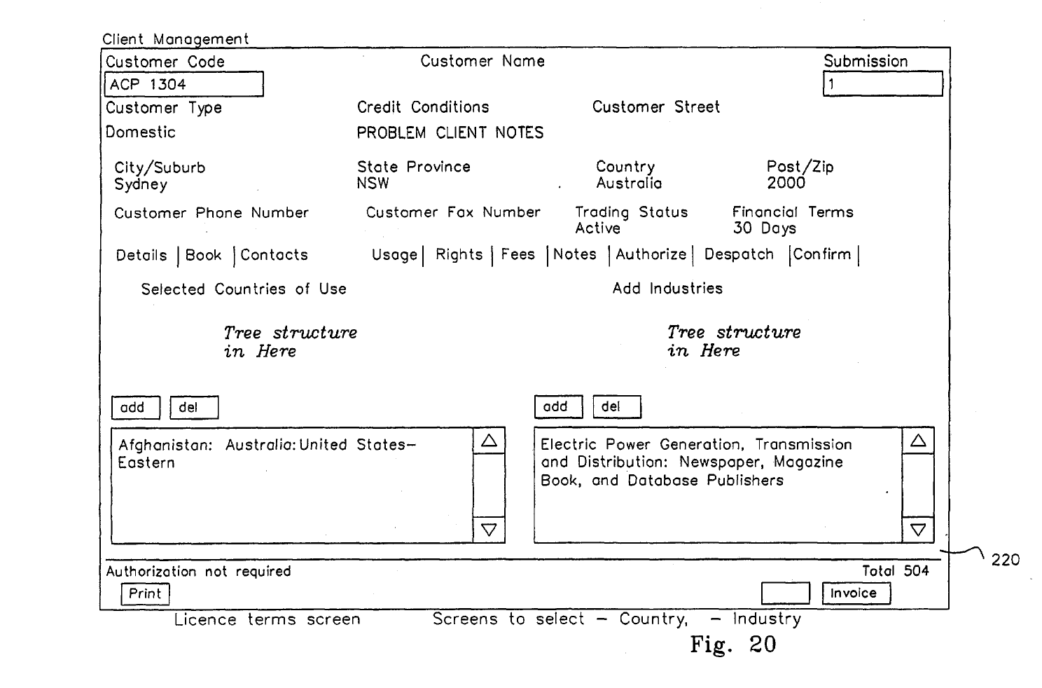

FIG. 20 illustrates a restriction and usage parameters screen 220, in this instance listing restrictions in relation to geographic location (by country) and restrictions in relation to nature of applicable industry.

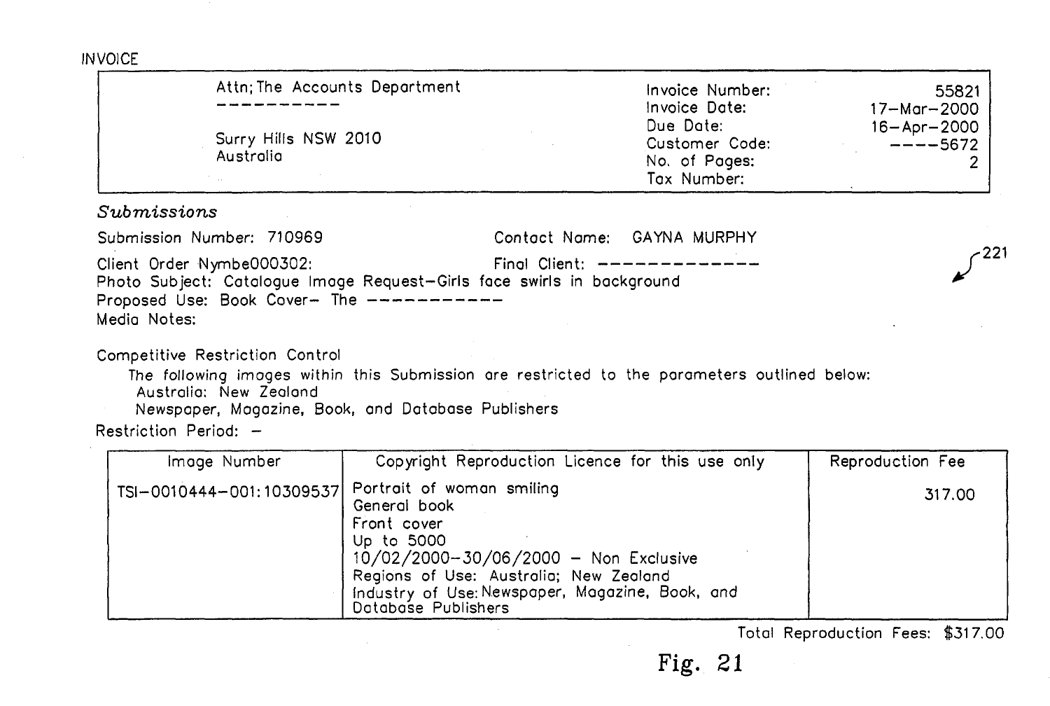

FIG. 21 illustrates an example of an invoice 221 (which can subsequently be conveyed via paper media or via electronic media) to a client. Payment of the invoice is a condition for subsequent trigger of the pay trigger 22 and the parallel pay process 23 previously described.

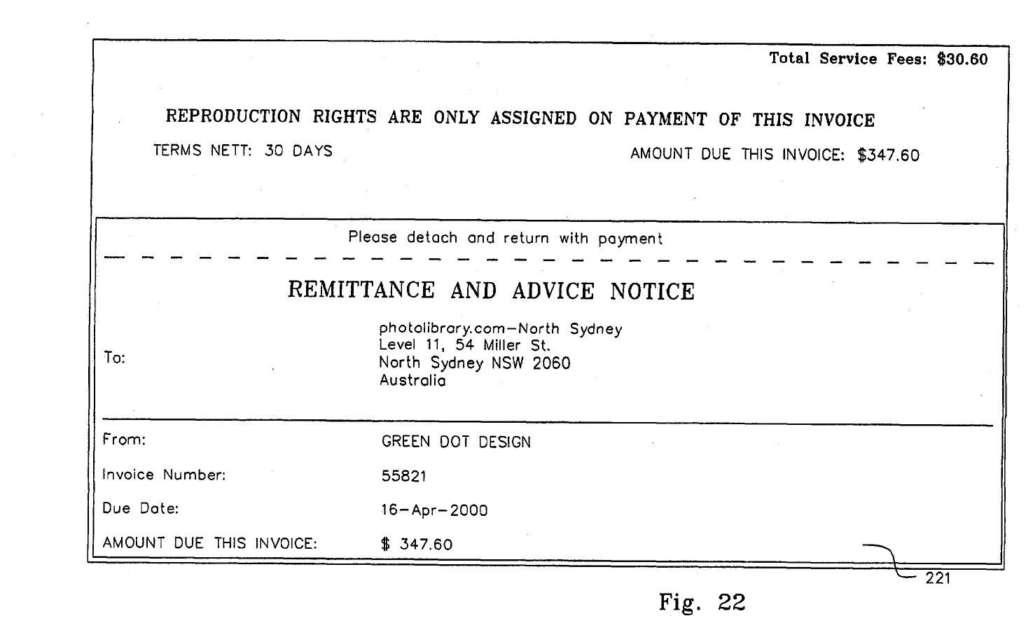

FIG. 22 is a continuation of the invoice 221 of FIG. 21.

6. Third Preferred Embodiment

With reference to FIGS. 23 to 26 inclusive a further embodiment of the invention with particular application to a wide area network or internet implementation will be described.

In this third embodiment the microlicensing system 310 includes components numbered as for the previous embodiments, but numbered in the 300 series. So, for example, the searchable database 11 of the first embodiment becomes searchable database 311 of the third embodiment.

Initially, with reference to FIG. 23, the microlicensing system 310 when accessed via a personal computer or other visual interface will present a welcome screen 331 which will provide to the prospective user 332 an introduction to the microlicensing system site and ensure that necessary precursor information 333 is communicated to user 332 prior to gaining access to or otherwise making commercial use of the microlicensing system 310. Such precursor information can include copyright information, copyright warnings and contractual matters by which the legal relationship between the (prospective) user 332 and the owner/operator of the microlicensing system 310 is defined and agreed.

Having negotiated the welcome screen 331 and prior to gaining access to the microlicensing database screens 334 some initial user data is processed through a pre-filter screen 335. The data obtained via the pre-filter screen 335 includes data relevant to dynamic filter 336 (corresponds with dynamic filter 122 of the earlier described modifications to the first and second embodiments). It can also include information relevant to the dynamic tagging device 337 (designated 112 in the description relevant to the earlier embodiments).

By way of example pre-filter screen 335 and the computer on which it runs can determine either indirectly, in some instances, or otherwise by direct enquiry of user 332 the geographic location of the user and the route by which the user 332 was directed to welcome screen 331. At its simplest level this information can be used by dynamic tagging device 337 to determine whether additional parties should be included in the list of stakeholders (should a transaction with user 332 subsequently ensue) and can also be utilised by dynamic display filter 336 to screen out from viewing by user 332 data elements which, with reference to the associated prior data component of those data elements, it has been determined are not to be made available to the geographic location of user 332.

Having negotiated the pre-filter screen 335 the user 332 is then permitted access to the database screens 334 at which point the user 332 can browse at least the licensable components of the data elements 316 according to keyword, subject matter category or otherwise.

In this embodiment the information derived through the pre-filter screen 335 is passed through the restriction builder 338. The restriction builder 338 maintains a database of criteria by which the use of the licensable components have been limited including, for example, by geographic area, by industry of application, by period of time.

Utilisation of the pre-filter screen 335 in conjunction with the dynamic display filter 336 and dynamic tagging device 337 ensures that a user 332 is provided for review only with those licensable components which are available to that user for licensing.

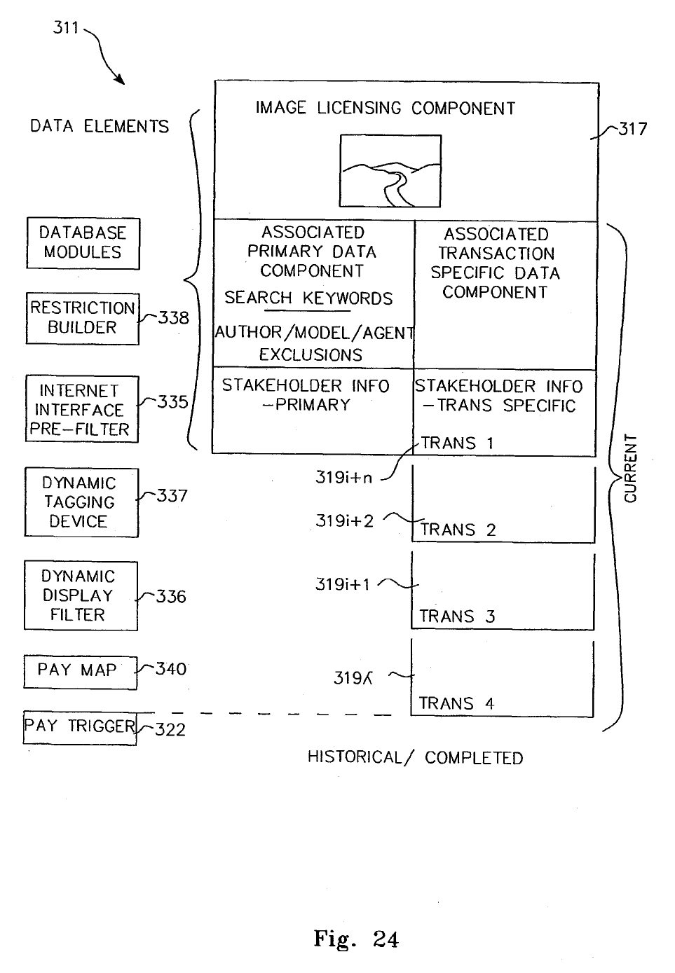

With reference to FIG. 24 some of the main components of system 310 and searchable database 311 are illustrated in diagrammatic form.

A functioning database will comprise of a significant plurality of data elements 316. Each data element 316 will include a licensable component comprising, in this instance, a unique image 317.

Forming part of the record for each data element 316 will be an associated primary data component 318 which comprises data relevant and pertinent to the unique image 317 of that particular data element. Typically data which falls into this category will include search keywords and subject matter categorisation specifically and directly relevant to the specific licensable component, in this instance an image 317. The data will also include the author of the image, the model who was the subject of the image (where relevant) and perhaps the agent responsible for organising the creation of the work.

Such data will also include usage exclusions arising from the author, model or agent.

The data will also include other relevant stake holder information which is directly relevant to that particular image and is unlikely to change whilst the image resides on the database 311.

Also and separately included in the data record for each data element 316 is an associated transaction specific data component 319. Each associated transaction-specific data component will be unique to each data element 316 and also unique to each specific commercial transaction which the licensable component of the data element 316 is the subject of. Hence, in typical use, there will be associated with data element 316 a plurality of associated transaction-specific data components 319 comprising components 319(1), 319(2), . . . 319(i), 319(i+1) . . . 319(i+n).

Included in each of these records will be data which is specific and unique to each commercial transaction of which the image comprising the licensable component is made the subject. Examples of such transaction-specific data can include additional stakeholders which have become stakeholders only as a result of the nature of the route by which the transaction has been entered. Elsewhere in this specification such stakeholders are referred to as “variable stakeholders”. A variable stakeholder can arise where, for example, a transaction is entered into via a third part route 339 (refer to FIG. 23) and the party associated with that third party route requires payment for its inclusion in the route by which the user 332 became a party to a transaction regarding the specific licensable component.

Transaction-specific data will also include financial data relevant to the commercial details unique to that transaction.

Important functional modules of microlicensing system 310 which work with and upon the data elements 316 include restriction builder 338, internet interface pre-filter screen 335, dynamic tagging device 337, dynamic display filter 336, dynamic pay map 340 and pay trigger 322, all of which are illustrated in block form in FIG. 24.

All of these modules interact with data elements 316 and also with dynamic pay map 340 and pay trigger 322 as will now be described.

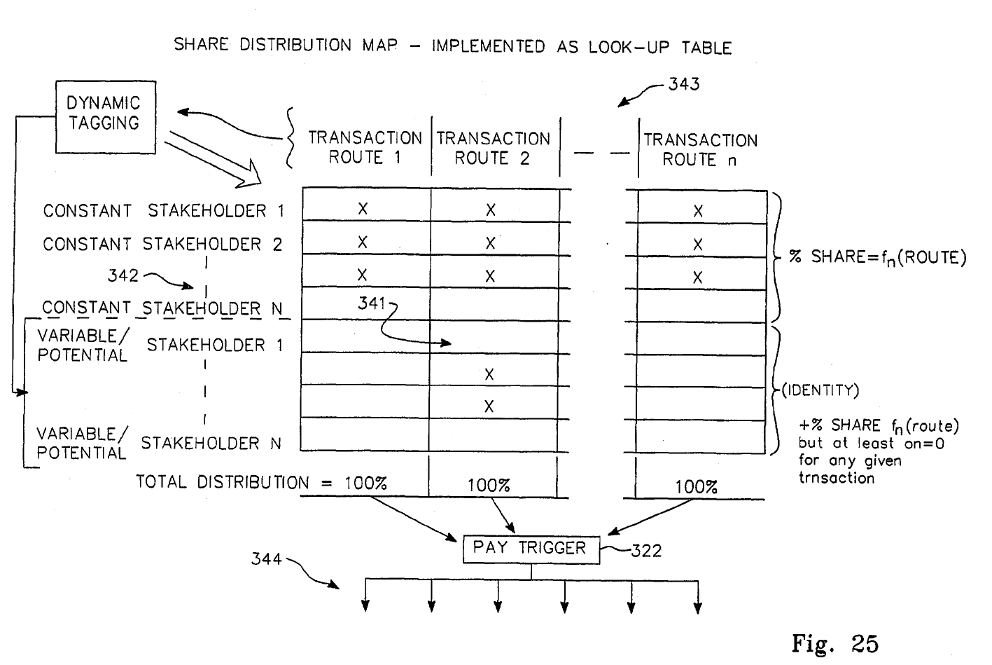

With reference to FIG. 25 dynamic pay map 340, in a two dimensional representation, and which corresponds to a specific transaction, in this instance provides stakeholder pay values 341 which are a function of at least two variables. In this instance the at least two variables comprise a first variable comprising stakeholder identity 342 and a second variable comprising transaction route 343.

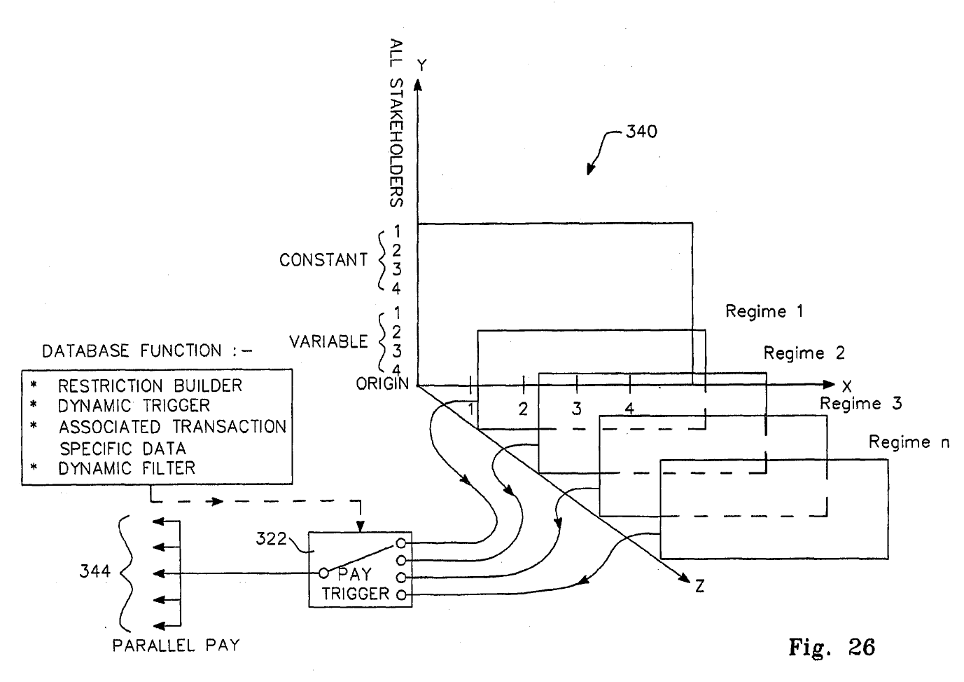

The multi-dimensional nature of the function by which the dynamic pay map 340 is further illustrated with reference to FIG. 26. It is seen more clearly from the three dimensional graph where the X axis identifies the transaction routes by which a particular license is arrived at; the Y axis provides the identity of all possible stakeholders; the Z axis denotes the various pay maps according to specific stakeholder grouping and where the various stakeholder groupings comprise defined selections from the group of all possible stakeholders as enumerated against the Y axis. The end result is that, in this example, there are, in effect, a plurality of pay maps, each defining a different pay regime selected, in this instance, from regime 1, regime 2 or regime 3 through to regime N, the regime selected being a function of transaction route and stakeholder grouping.

Once a specific regime is determined by reference to this function the selected pay map is made available to pay trigger 322 as the pay regime to be used to calculate the pay amounts for each and every stakeholder of the selected grouping 344.

This arrangement allows each and every one of the stakeholders to have their entitlement arising from the specific transaction and according to the pay map, to be calculated at the same time.

It may be, in this embodiment, that having calculated the amounts due to each and every stakeholder that physical payment may itself be delayed for reasons such as, for example, the desire of a given stakeholder to receive all payments lumped together over a predetermined time span which may well cover a plurality of transactions in which that stakeholder is entitled to payment. Nonetheless, the calculation as to entitlement for that specific stakeholder will be done at the same time as the calculation for all other stakeholders for any given transaction.

The above described embodiments have been exemplified by reference to data elements in the form of digital images.

Other data elements of a wide variety can be made the subject of the microlicensing system 10.

In particular the system can be applied to the regulation of other copyright works such as moving images (films) with or without accompanying audio and the like, particularly when reduced to a digital form.

7. Fourth Preferred Embodiment

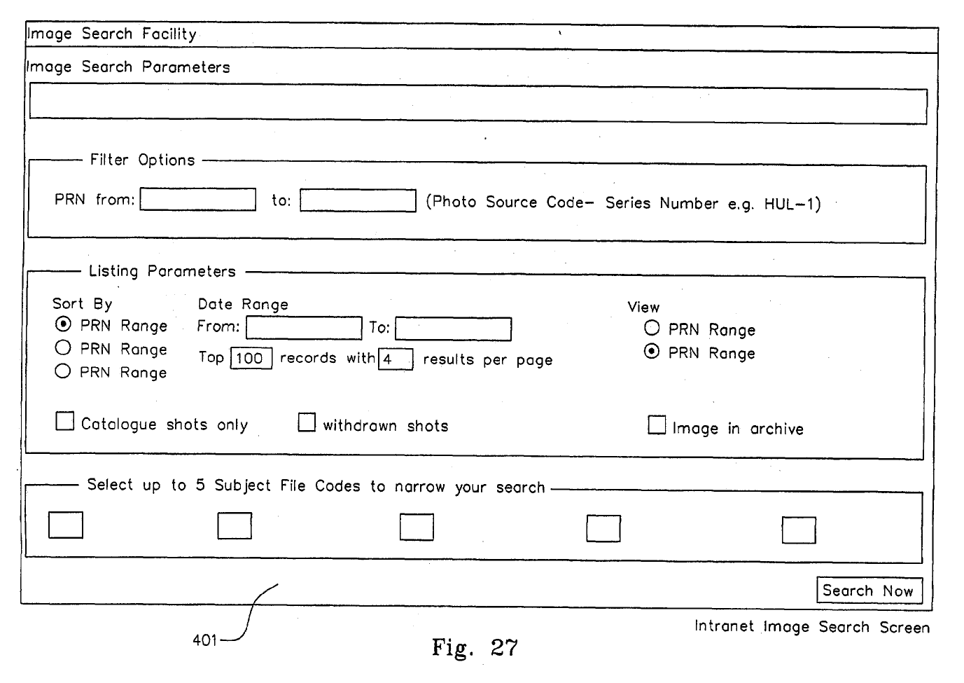

With reference to FIGS. 27 onwards there is described a fourth preferred embodiment of the present invention which, in use, and from the point of view of a user operating either a local intranet terminal or a remote internet connected terminal interacts with screen presentations in the following manner:

A prospective licensor is first presented with screen 401 which permits the licensor to search on predetermined parameters for licensable material. In this instance the search is for licensable material categorized by the search term “people”. In this instance the screen 401 is available on a corporate intranet and, as such, permits access to all licensable materials.

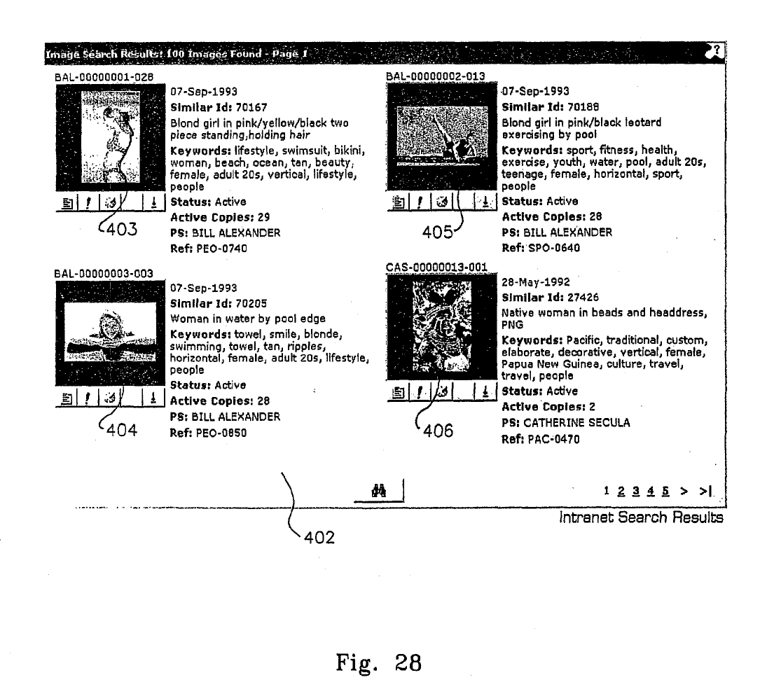

In this instance, as shown in FIG. 28 the intranet search result screen 402 brings up four possible licensable images 403, 404, 405, 406.

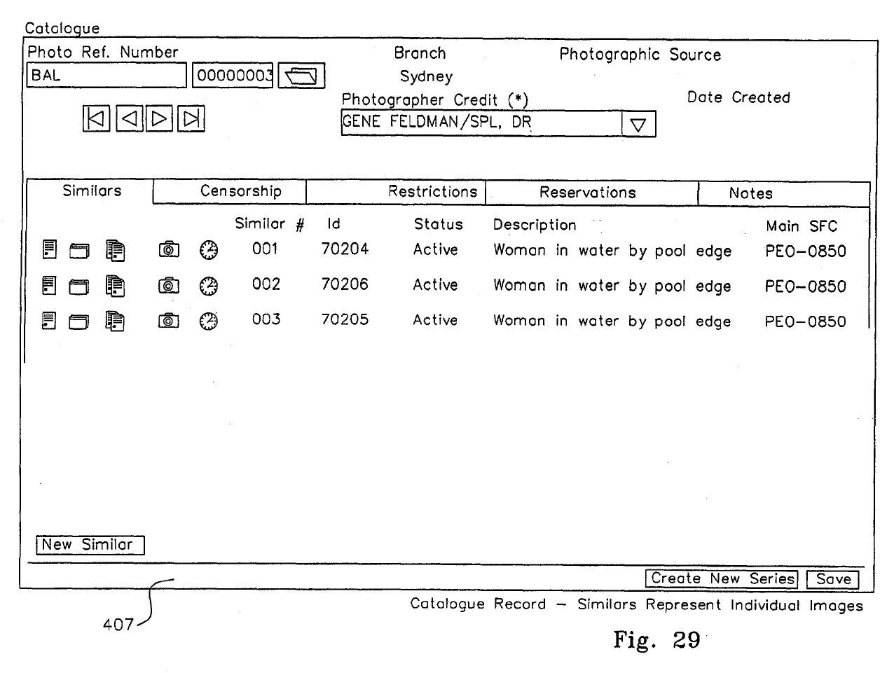

As shown in FIG. 29 the user may select one of the images 403, 404, 405, 406 and view catalogue details of that image and related or “similar” images as represented in screen representation 407.

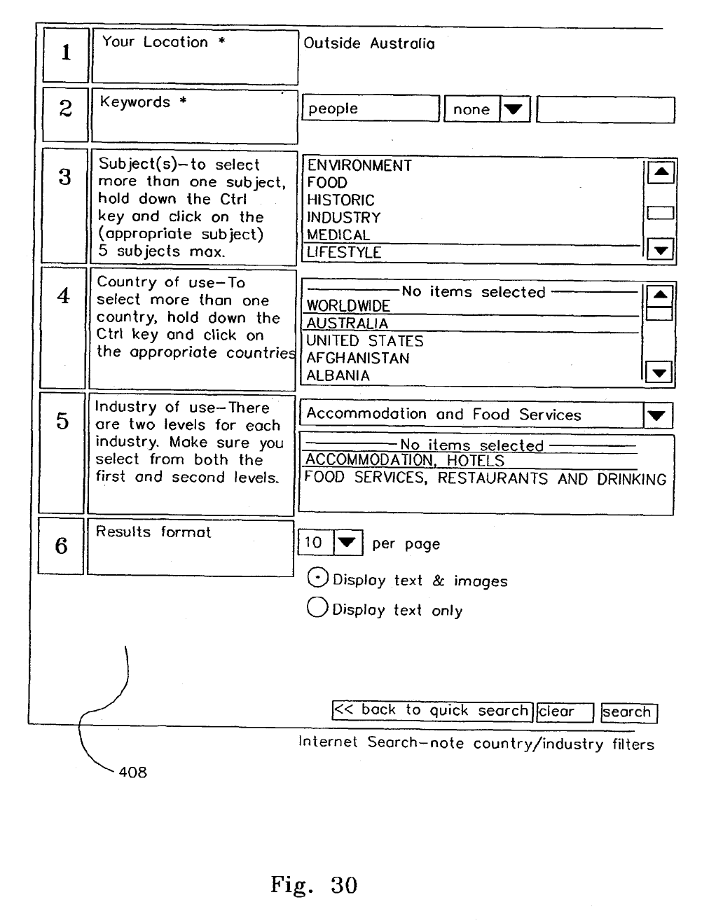

FIG. 30 illustrates an initial search screen 408 which is available to users operating a terminal connected, for example, via the internet to a bureau service offering licensable materials. In this instance the screen 408 represents a filter screen which allows the user to designate some basic expected conditions under which the user would utilize licensable materials. By making the appropriate designations the search will be restricted only to licensable materials which would be available to be licensed to the user under the conditions the user has nominated in the search screen 408.

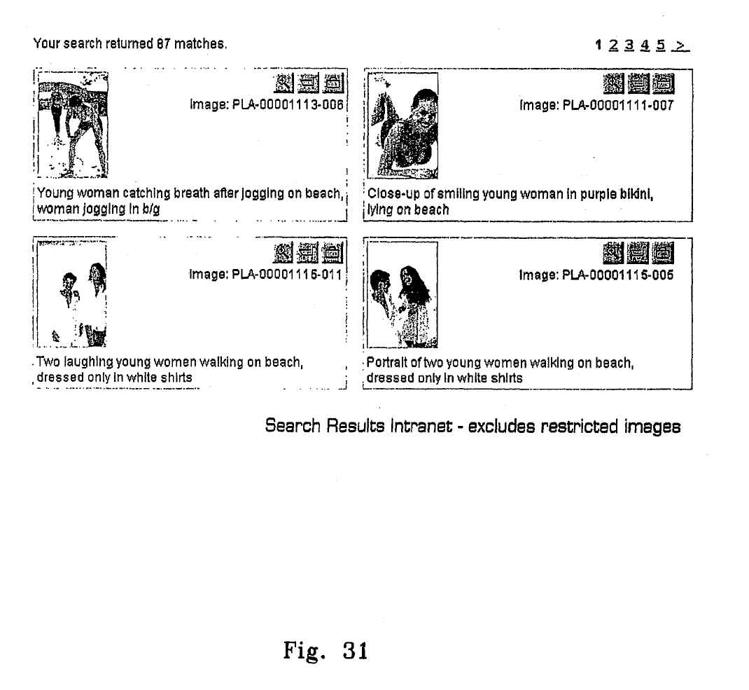

Screen 409 in FIG. 31 illustrates a typical search result screen 409 showing four available images 410, 411, 412, 413. These images are available for licensing in that their use would not be precluded in accordance with the conditions selected by the prospective user on screen 408.

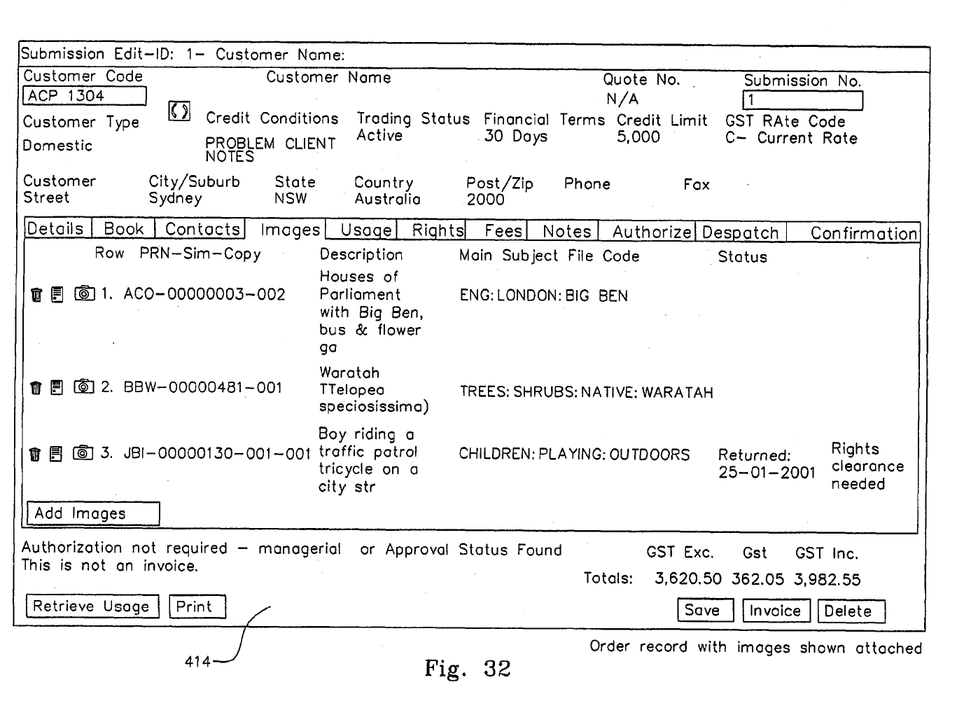

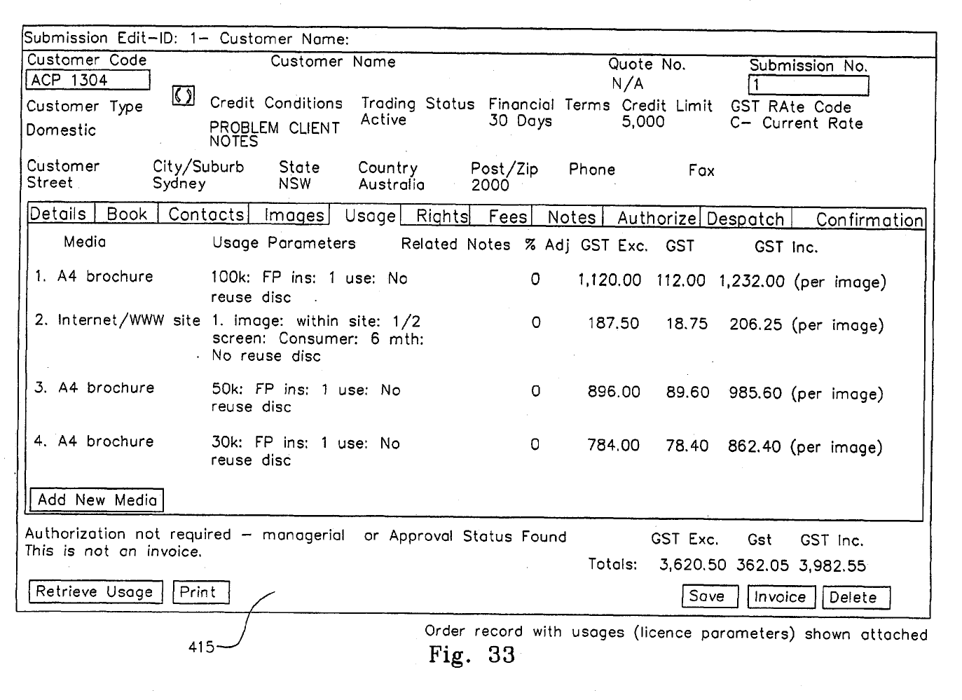

The user may then “click through” to a series of order records for any one of the available images 410, 411, 412, 413. Typical order records are shown as screen images 414 in FIGS. 32 and 415 in FIG. 33.

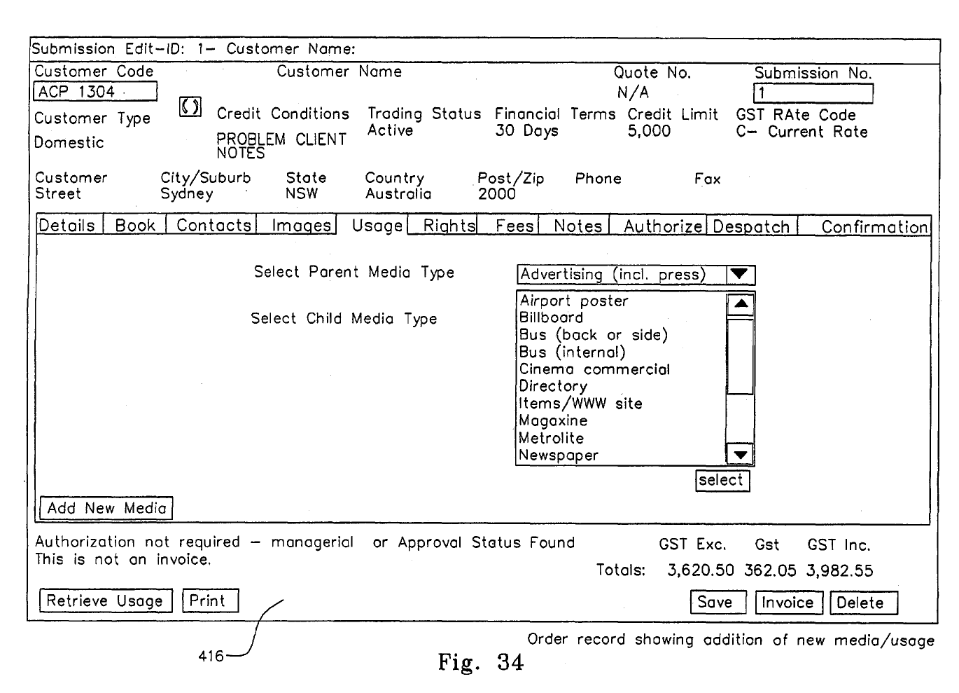

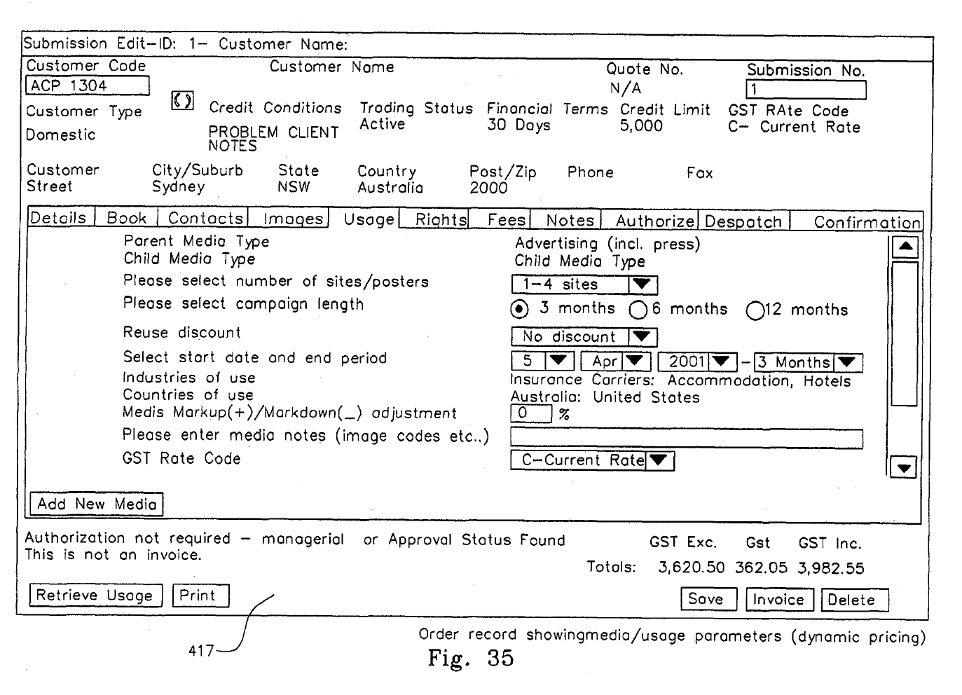

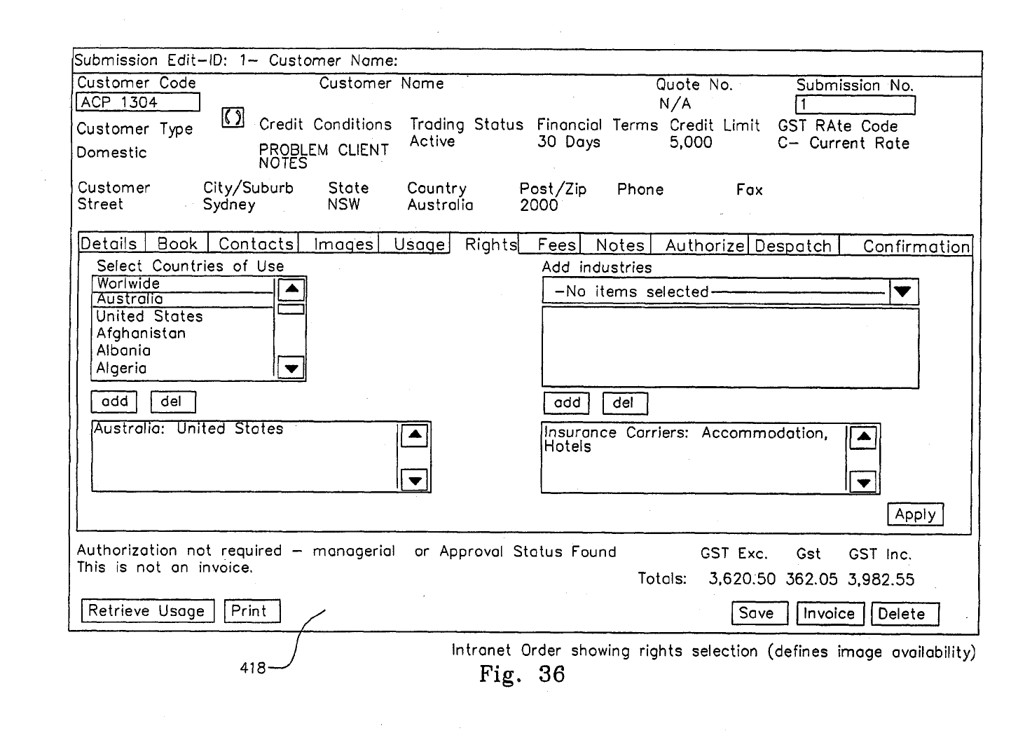

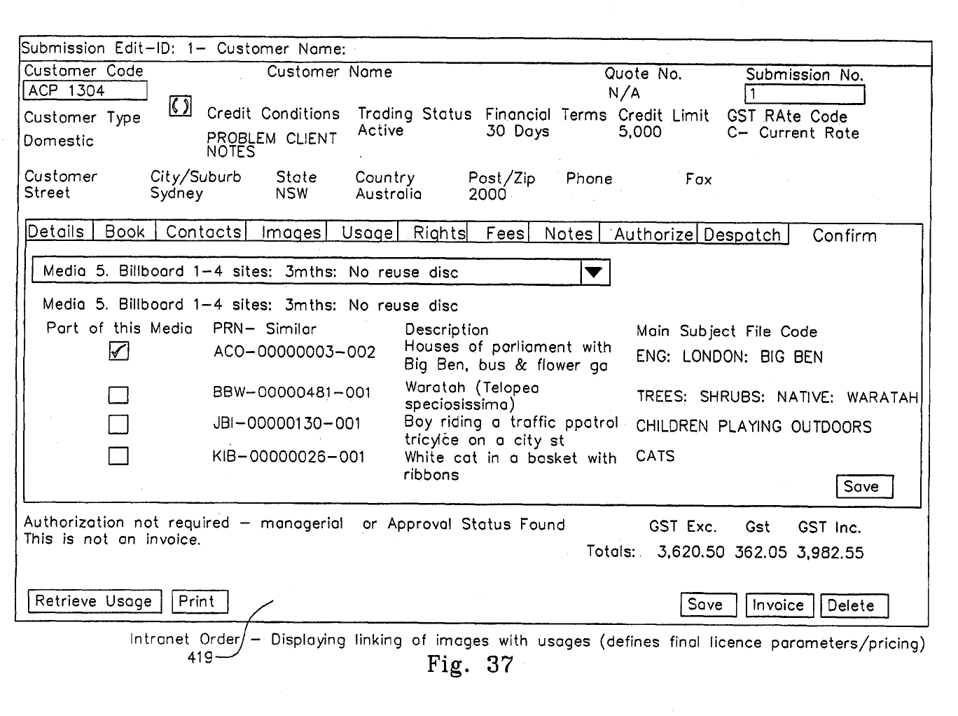

Having settled on an image which the user desires to license the user must then communicate contract details including proposed media usage in screen 416 of FIG. 34, magnitude of media usage and period of usage entered as per screen 417 in FIG. 35 and geographical location of usage as entered via screen 418 in FIG. 36 and as summarized prior to ordering in screen 419 in FIG. 37.

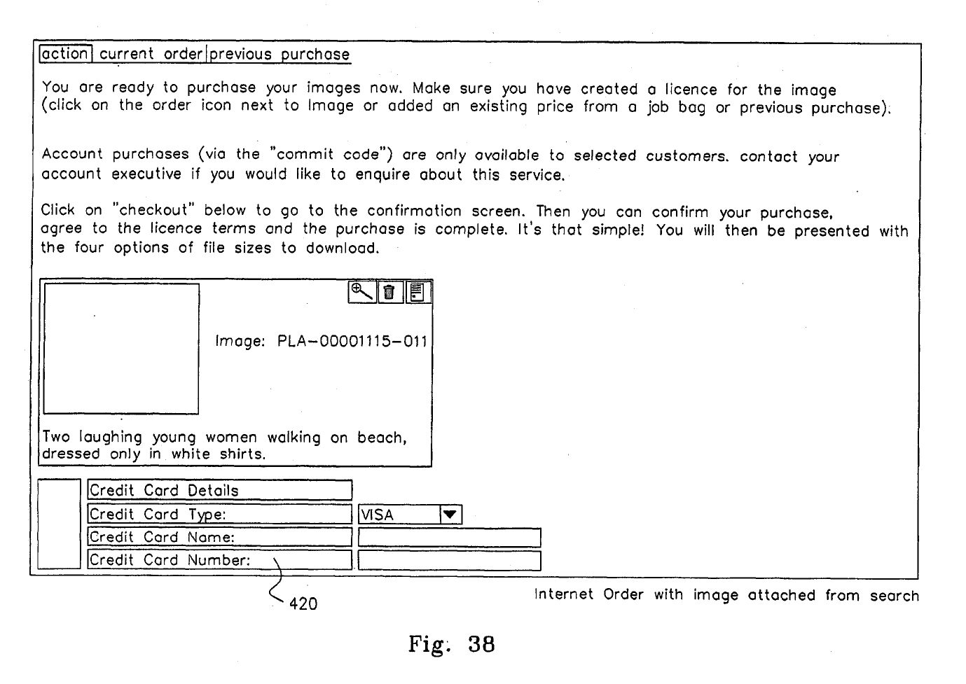

Having selected and confirmed both the licensable material (image) which a user wishes to license and the terms upon which the media will be used the user may then pay for issue of the license as shown in screen 420 in FIG. 38.

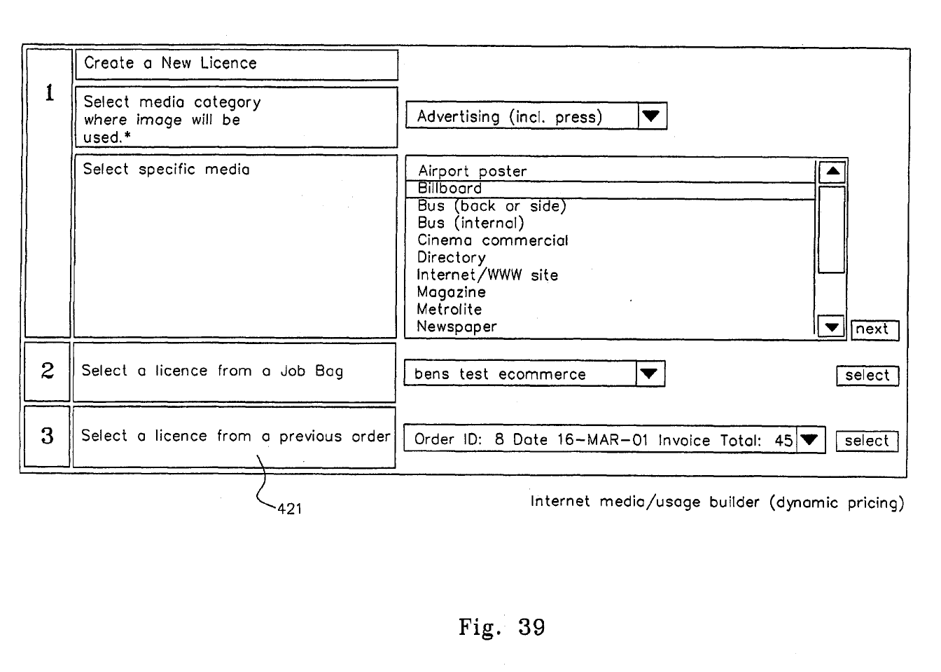

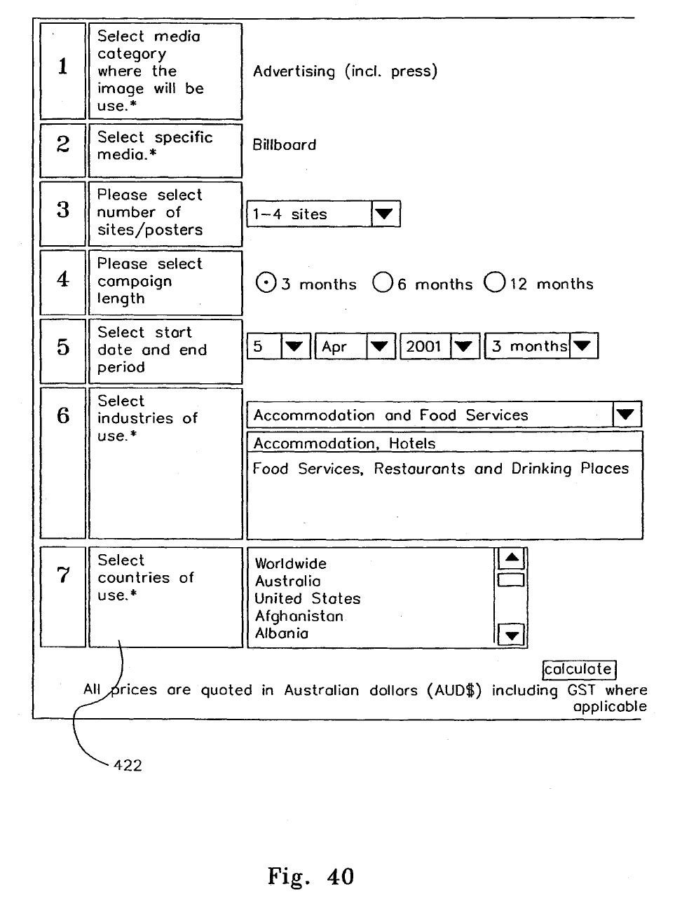

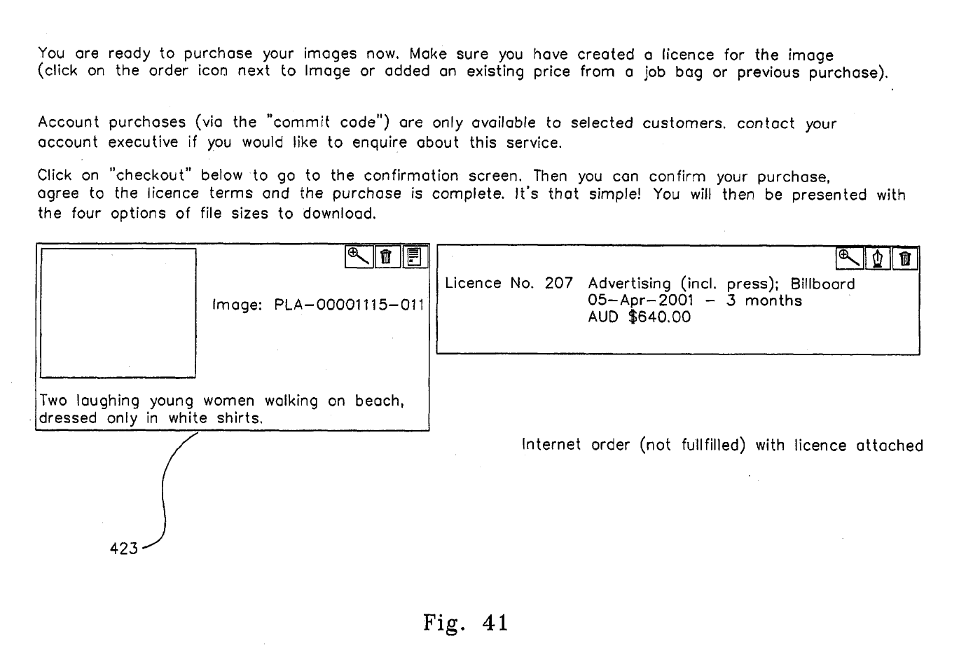

A similar process can be undertaken via internet communication as illustrated in screens 421 of FIG. 39, 422 of FIGS. 40 and 423 of FIG. 41.

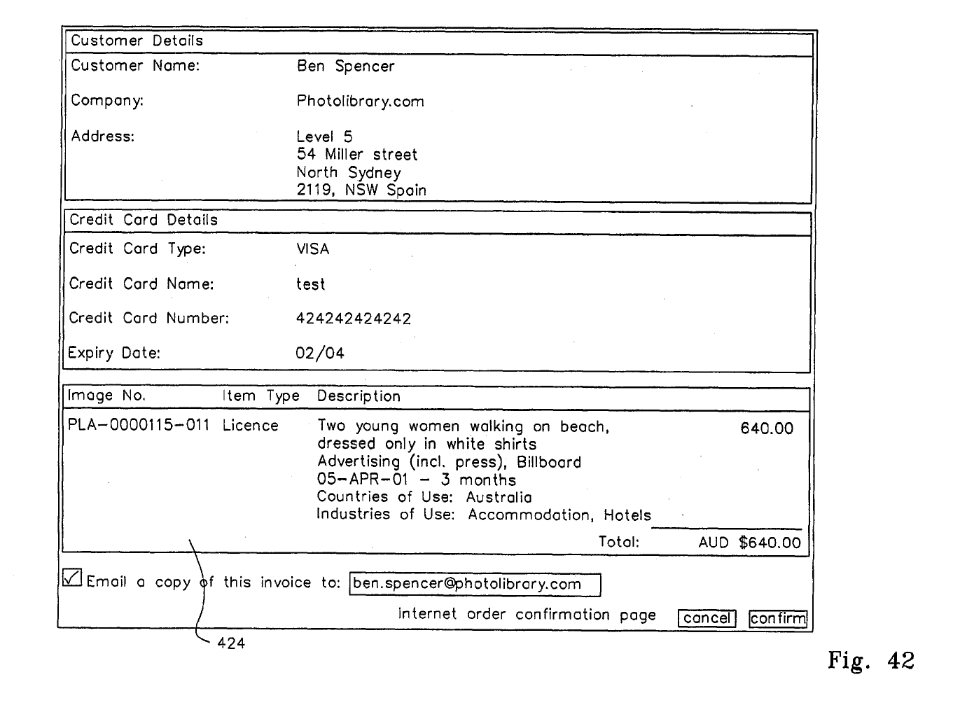

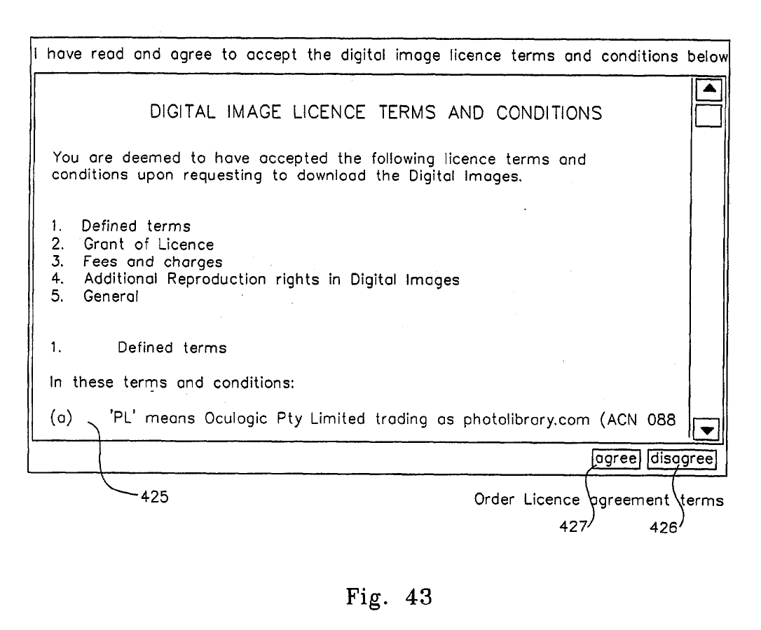

The culmination of the order process whether completed, by internet or intranet results in the display of the license terms and conditions via screen 424 in FIG. 42 and the presentation, by way of final confirmation of the transaction, of the entire terms of the license as shown in screen 425 of FIG. 43 to which the prospective licensee must officially positively select either a “disagree” button 426 of an “agree” button 427.

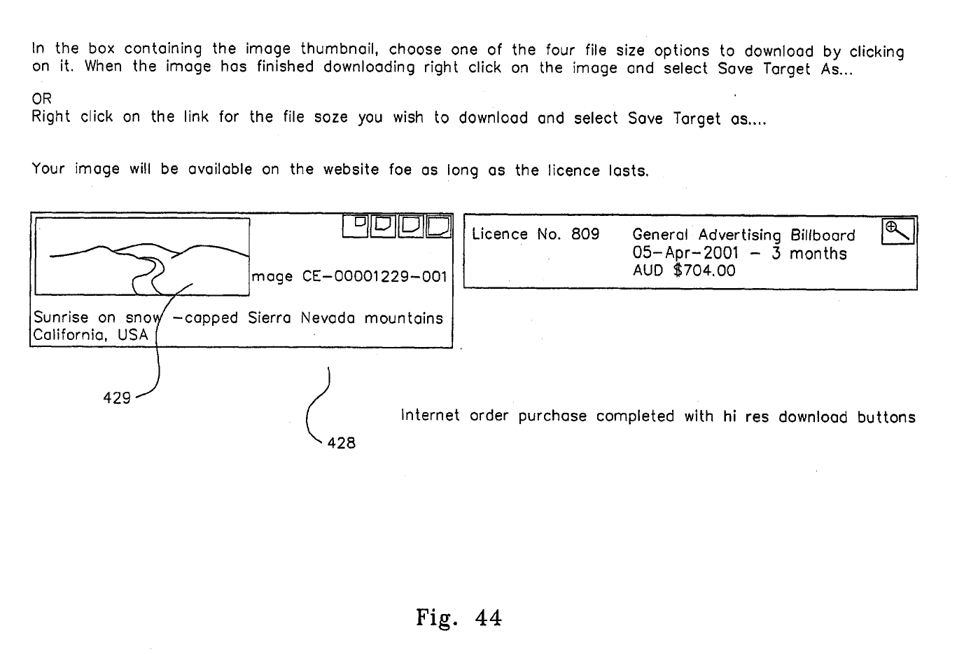

If the user presses the “agree” button 427 then, as shown in screen 428 of FIG. 44 the licensed media, in this instance image 429 can be downloaded as a high resolution image by clicking on download button 430. At this point the account of the user is debited the agreed license fee and the image is made available electronically (or alternatively by manual methods at the option of the user) and the parallel calculate and parallel pay process is instigated.

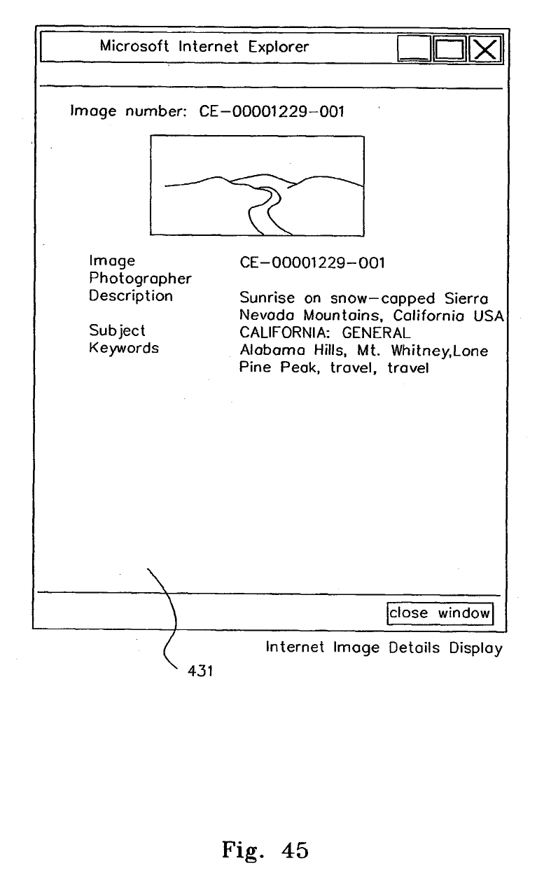

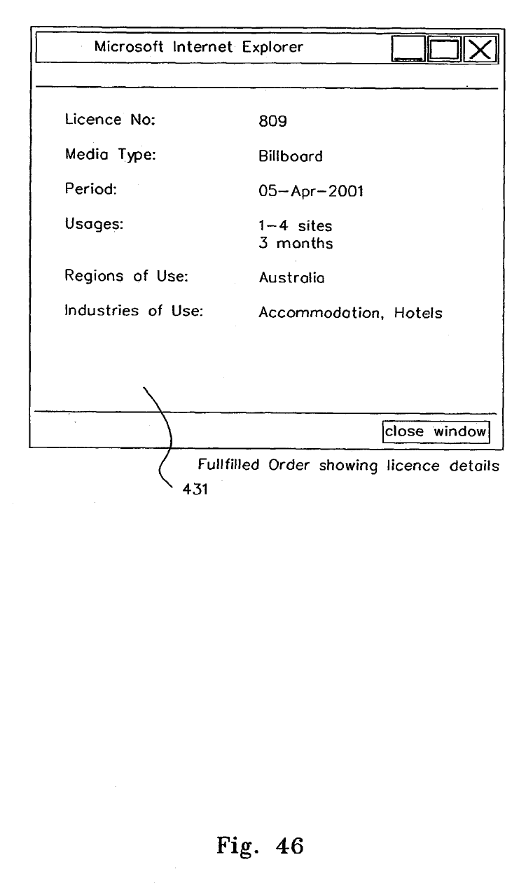

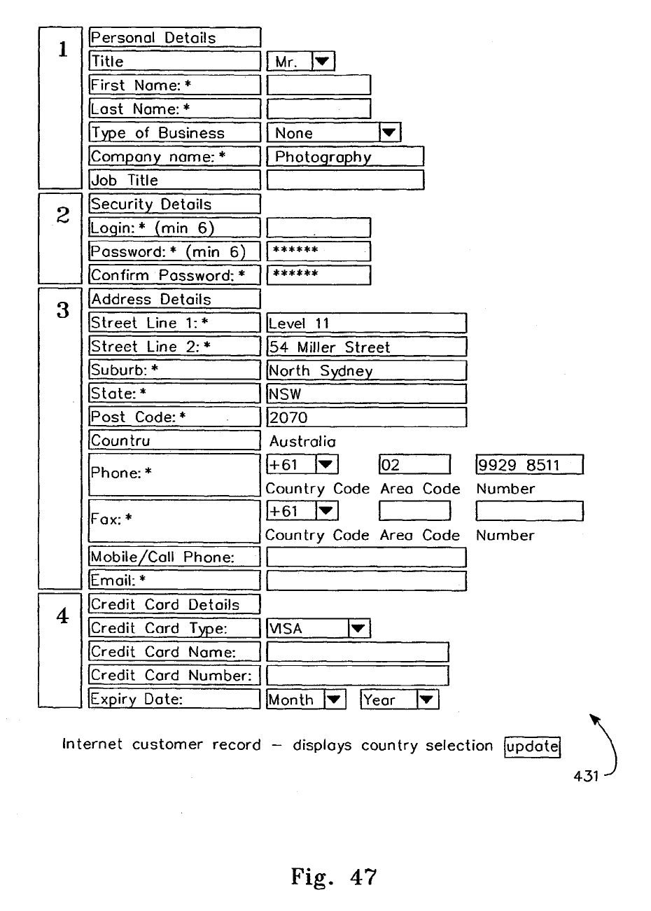

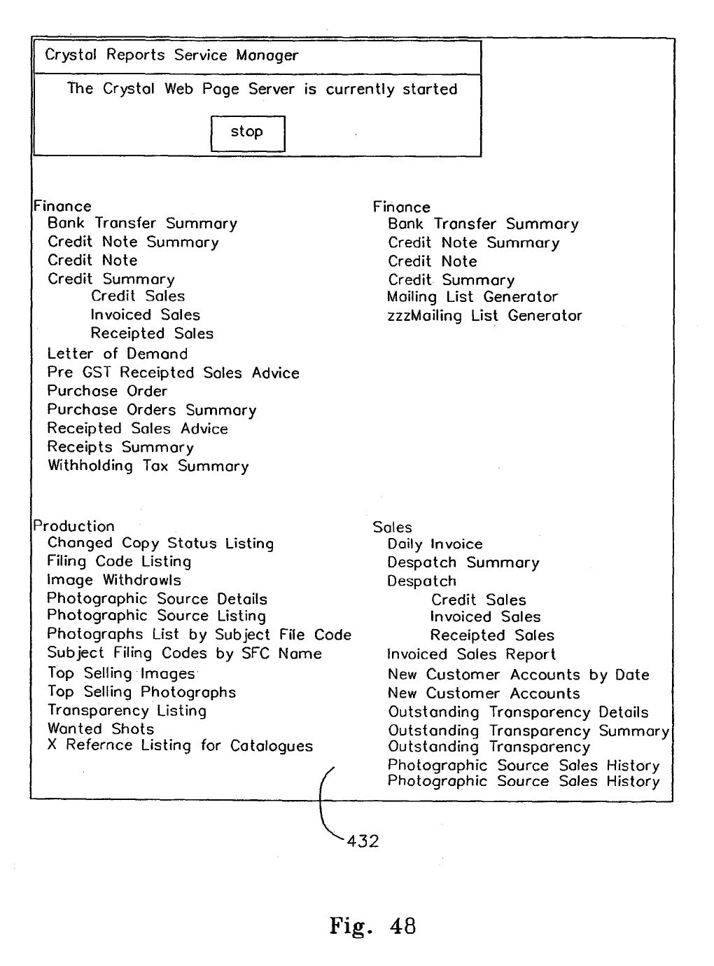

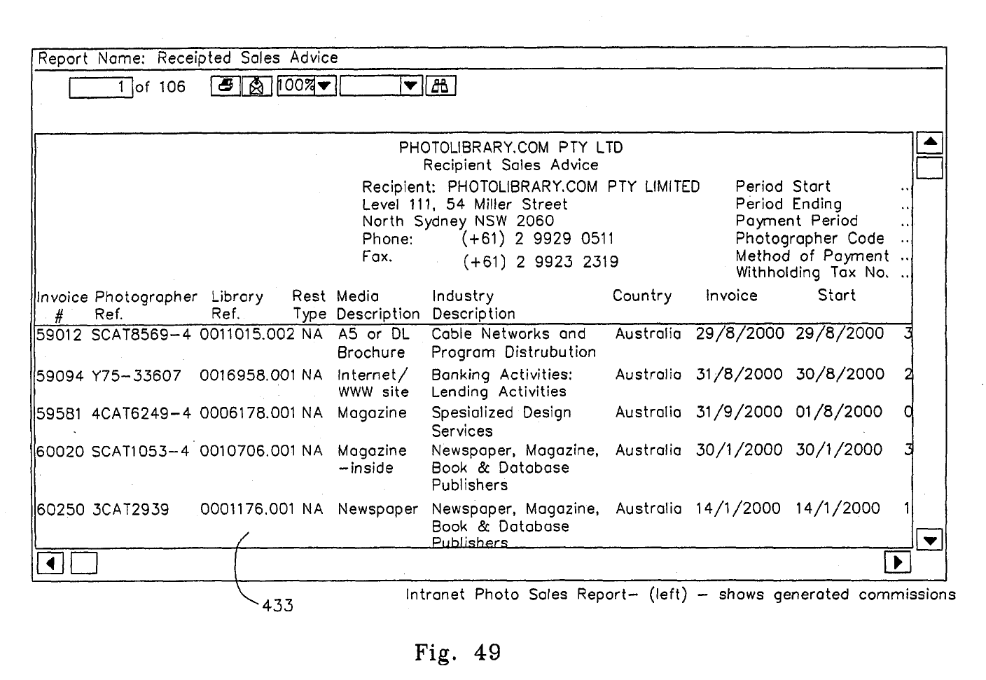

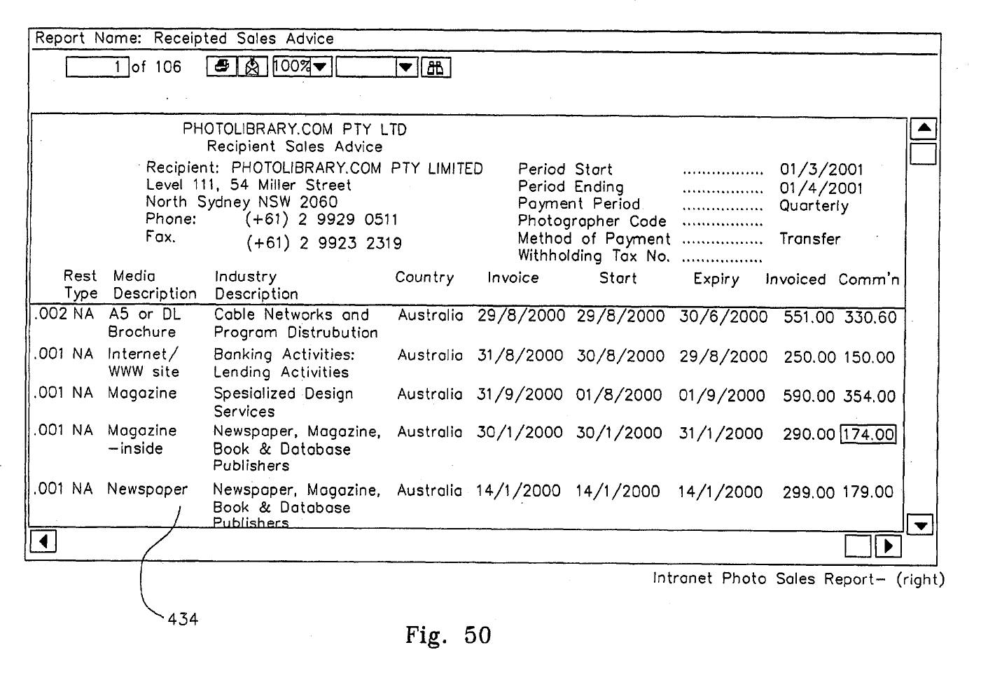

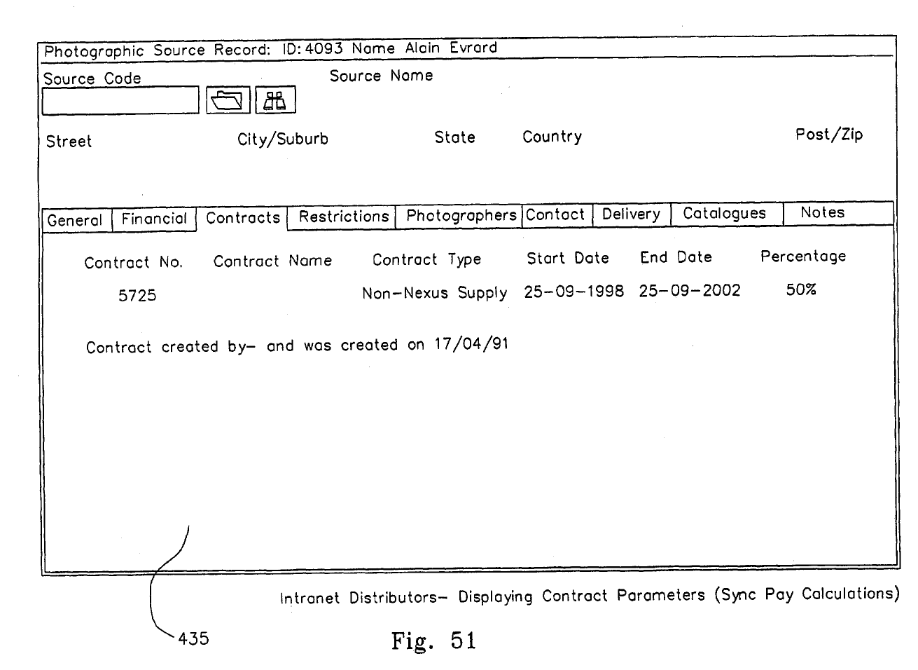

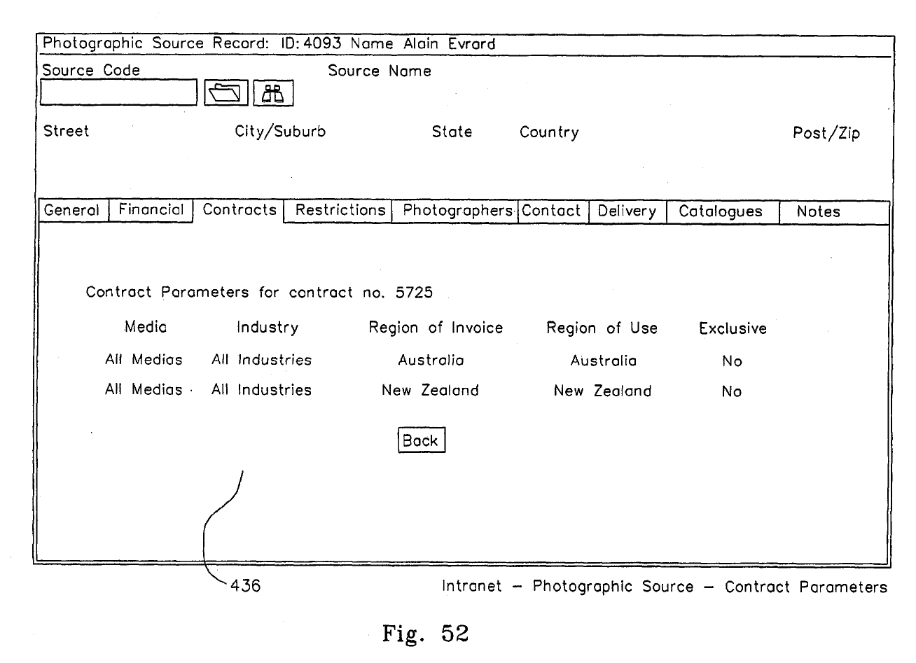

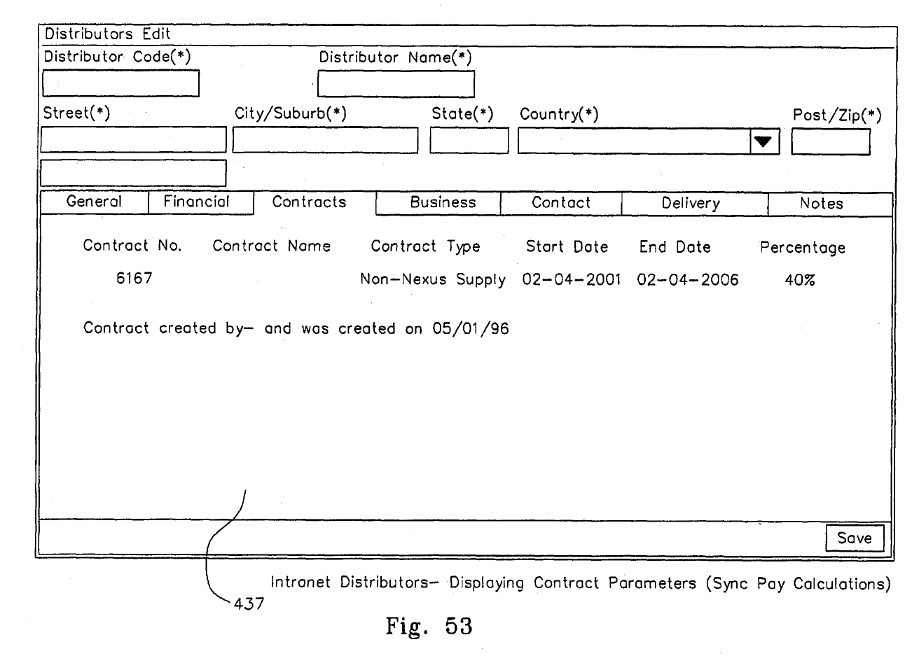

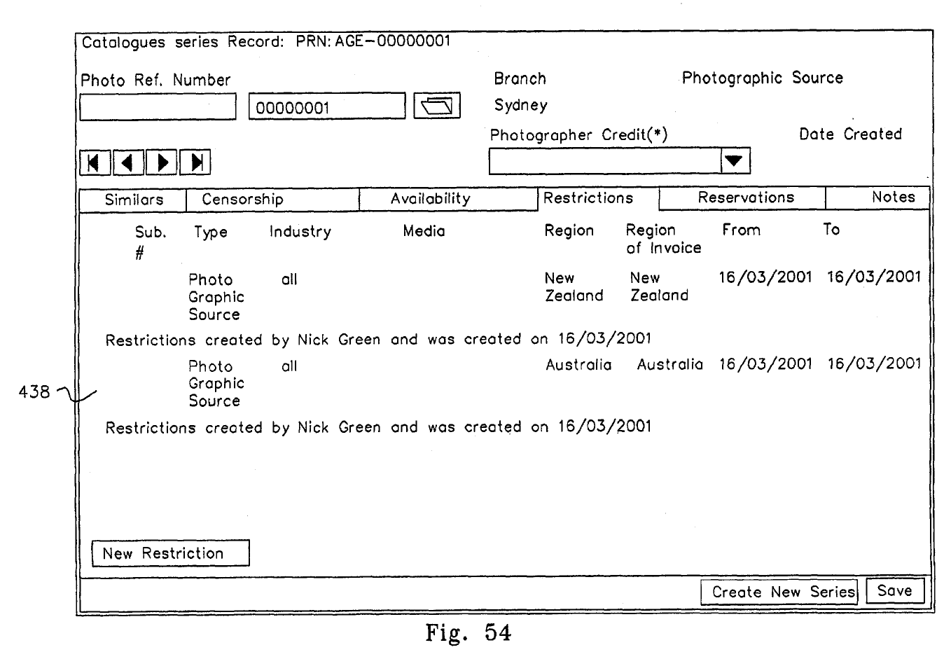

At this point the user, having entered into the licensing contract now has available, as shown in FIGS. 45, 46 and 47 full details of the license and high resolution image as summarized in record 431 whilst, at the same time, the bureau or other agency operating the microlicensing system and method according to preferred embodiments of the present invention has available a full summary of the transaction as illustrated by records 432, 433, 434, 435, 436, 437, 438 in FIGS. 48 through to 54.

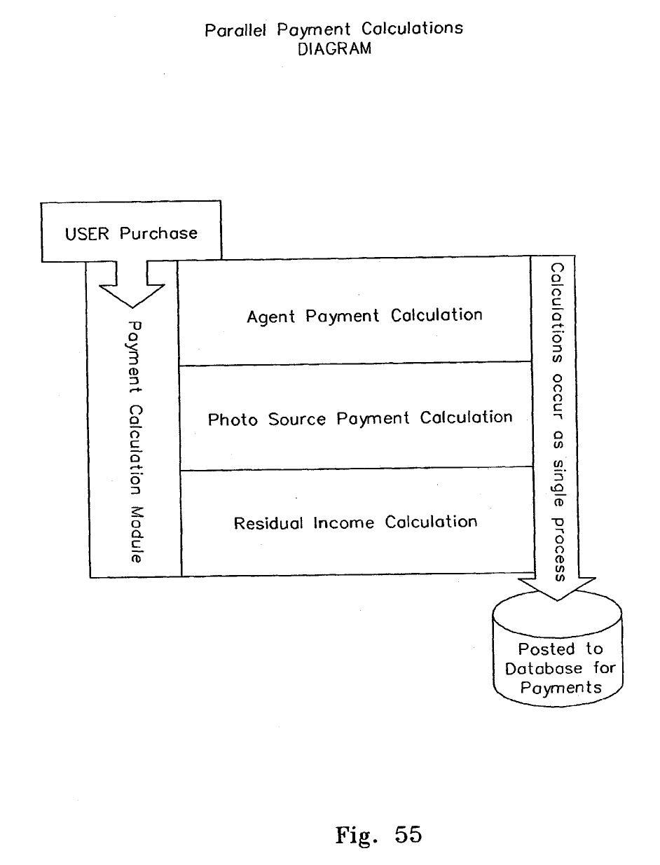

Importantly, as part of the record calculation, as illustrated in FIG. 55, the liabilities of the agent to all interested parties are calculated in parallel in accordance with parallel process 439 and are then posted to a payments database 440 for payment, in preferred forms also in parallel.

It will be observed that the entire process starting with the screen images presented to a prospective licensee in FIG. 27 through to the parallel payment calculation and actual payment process of FIG. 55 can be accomplished electronically and substantially in real time.

In preferred forms the system can be programmed in high level programming languages such as C++ and implemented to run on operating systems such as the “Windows” operating system and interfaces marketed by Microsoft Corporation with the assistance of the program building packages such corporations provide.

8. Fifth Preferred Embodiment

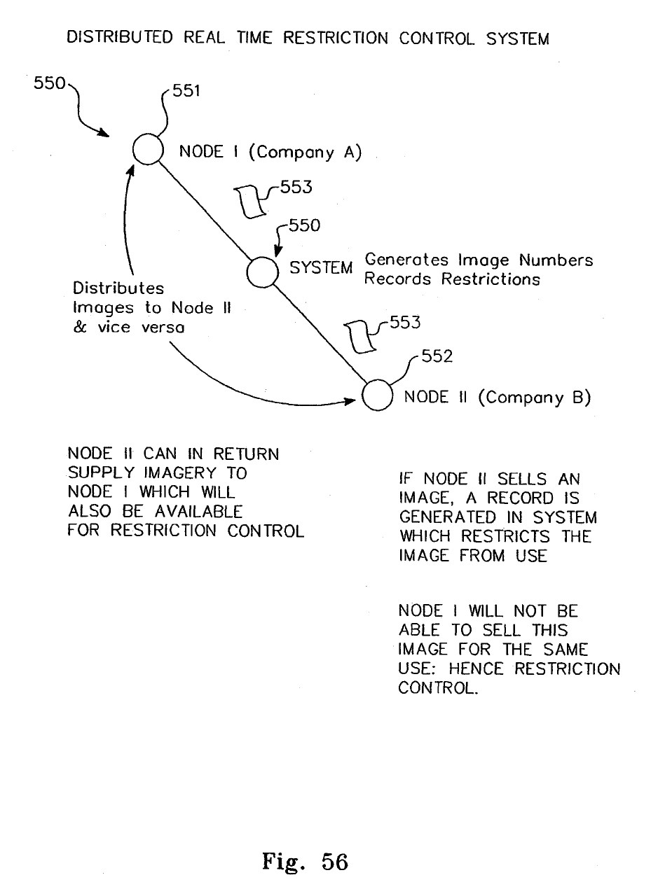

With reference to FIG. 56 there is illustrated a distributed real time restriction control system 550 which, in this embodiment, utilizes only the restriction control portions of the system described with reference to previous embodiments.

In this embodiment at least a first bureau or licensing entity 551 is able to communicate with an at least second bureau or licensing entity 552 for the case where the entities have available the same images 553 or other licensable data. Both entities 551, 552 communicate at least the restrictions placed on any license they issue in respect of image 553 to the other entity as soon as any one entity executes a license in respect of image 553. The restriction data is available on the database of each entity 551, 552 immediately and as if that entity had executed the license thereby to ensure that any enquiries from prospective licensees for image 553 will be aware of restrictions in place on the image 553.

In this preferred form submodules of the restriction software of previous embodiments are incorporated in the database software of each entity 551, 552.

The above describes only some embodiments of the present invention and modifications, obvious to those skilled in the art, can be made thereto without departing from the scope and spirit of the present invention.

### INDUSTRIAL APPLICABILITY

Embodiments of the above referenced microlicensing system and method can be implemented either in special purpose hardware communicating via telecommunications networks or, alternatively, can be implemented by the programming of server computer systems. In either case prospective licensees of licensable media including but not limited to digital still images, digital video images and combined digital video and audio data can be made available directly over electronic media such as corporate intranets or the worldwide interconnection of computers and servers currently known as the Internet.

1. A microlicensing system comprising:
(a) a searchable database of licensable data elements;
(b) search and select means which allows a user to select an individual one of said data elements according to criteria set by said user;
(c) means for setting terms and conditions for use of said individual one of said data elements so as to define an identifiable transaction;
(d) means for transmission of said individual one of said data elements to a user device; said user device enabling usage of said individual one of said data elements.

2. The system of claim 1 wherein said data element includes a licensable component comprising an image component.

3. The system of claim 1 wherein said data element includes associated primary data.

4. The system of claim 1 wherein said data element includes associated transaction-specific data.

5. The system of claim 3 wherein said primary data includes author identity, model identity and agent identity information.

6. The system of claim 4 wherein said associated transaction-specific data includes license terms, license constraints and financial data.

7. The system of any previous claim further including a pay trigger.

8. The system of claim 7 wherein said pay trigger causes calculation of payments at substantially the same time for all stakeholders identified by said system as party to said identifiable transaction.

9. The system of any one of claims 1 to 8 wherein said searchable database incorporates a microprocessor and memory.

10. The system of any previous claim further including an encapsulation device for encoding of at least portions of said desired one of said data elements.

11. The system of any previous claim further including decoding software.

12. The system of claim 11 wherein said decoding software is implemented as a shell program.

13. The system of any one of claims 1 to 12 wherein said search and select means incorporates a dynamic tagging means.

14. The system of claim 13 wherein said dynamic tagging means comprises a dynamic tagging device.

15. The system of claim 14 wherein said dynamic tagging device logs customer data including customer route data.

16. The system of claim 15 wherein payment to stakeholders and the identity of stakeholders is a function of said payment route data.

17. The system of any one of claims 1 to 12 wherein said search and select means incorporates dynamic filter means.

18. The system of claim 17 wherein said dynamic filter means permits browsing of at least the licensable portions of said data elements according to predetermined filter criteria.

19. The system of claim 18 wherein said predetermined filter criteria include one or more of geographic origin of prospective user, area of commercial endeavour in which said prospective user operates.

20. The system of any one of claims 1 to 19 incorporating a dynamic pay map means by which payments to all of the individual ones of said stakeholders are determined.

21. The system of claim 20 wherein said dynamic pay map means determines payments as a function of at least a first variable and a second variable.

22. The system of claim 21 wherein said first variable comprises transaction route and said second variable comprises stakeholder identity.

23. The system of claim 22 wherein said second variable is comprised of a constant grouping and a variable grouping.

24. The system of claim 23 wherein said constant grouping comprises a constant stakeholder grouping.

25. The system of claim 23 or 24 wherein said variable grouping comprises a variable stakeholder grouping.

26. The system of any one of claims 20 to 25 wherein said dynamic pay map means determines payments as a function of at least a first variable and a second variable.

27. The system of claim 26 wherein said variables are dynamically allocated by one or more of said dynamic tagging device and said dynamic filter device.

28. A method of microlicensing works for the benefit of all of the individual ones of a plurality of stakeholders; said method comprising utilising a microlicensing system comprising:
(a) a searchable database of licensable data elements;
(b) search and select means which allows a user to select an individual one of said data elements according to criteria set by said user;
(c) means for setting terms and conditions for use of said individual one of said data elements so as to define an identifiable transaction;
(d) means for transmission of said individual one of said data elements to a user device; said user device enabling usage of said individual one of said data elements.

29. The method of claim 28 wherein said data element includes a licensable component comprising an image component.

30. The method of claim 28 wherein said data element includes associated primary data.

31. The method of claim 28 wherein said data element includes associated transaction-specific data.

32. The method of claim 31 wherein said primary data includes author identity, model identity and agent identity information.

33. The method of claim 32 wherein said associated transaction-specific data includes license terms, license constraints and financial data.

34. The method of any one of claims 28 to 33 further including a pay trigger.

35. The method of claim 34 wherein said pay trigger causes calculation of payments at substantially the same time for all stakeholders identified by said system as party to said identifiable transaction.

36. The method of any one of claims 28 to 35 wherein said searchable database incorporates a microprocessor and memory.

37. The method of any one of claims 28 to 36 further including an encapsulation device for encoding of at least portions of said desired one of said data elements.

38. The method of any one of claims 28 to 37 further including decoding software.

39. The method of claim 38 wherein said decoding software is implemented as a shell program.

40. The method of any one of claims 28 to 39 wherein said search and select means incorporates a dynamic tagging means.

41. The method of claim 40 wherein said dynamic tagging means comprises a dynamic tagging device.

42. The method of claim 41 wherein said dynamic tagging device logs customer data including customer route data.

43. The method of claim 42 wherein payment to stakeholders and the identity of stakeholders is a function of said payment route data.

44. The method of any one of claims 28 to 43 wherein said search and select means incorporates dynamic filter means.

45. The method of claim 44 wherein said dynamic filter means permits browsing of at least the licensable portions of said data elements according to predetermined filter criteria.

46. The method of claim 45 wherein said predetermined filter criteria include one or more of geographic origin of prospective user, area of commercial endeavour in which said prospective user operates.

47. The method of any one of claims 28 to 46 incorporating a dynamic pay map means by which payments to all of the individual ones of said stakeholders are determined.

48. The method of claim 47 wherein said dynamic pay map means determines payments as a function of at least a first variable and a second variable.

49. The method of claim 48 wherein said first variable comprises transaction route and said second variable comprises stakeholder identity.

50. The method of claim 49 wherein said second variable is comprised of a constant grouping and a variable grouping.

51. The method of claim 50 wherein said constant grouping comprises a constant stakeholder grouping.

52. The method of claim 50 or 51 wherein said variable grouping comprises a variable stakeholder grouping.

53. The method of any one of claims 48 to 52 wherein said dynamic pay map means determines payments as a function of at least a first variable and a second variable.

54. The method of claim 53 wherein said variables are dynamically allocated by one or more of said dynamic tagging device and said dynamic filter device.

55. A method of calculation of payments to stakeholders; said method comprising calculating according to a pay map the return due to all of the individual ones of said stakeholders at the one time.

56. Storage media containing software operable according to the system of any one of claims 1 to 27.

57. A distributed real-time restriction control system wherein at least a first licencing entity and a second licencing entity can licence substantially identical licencable elements into common territory; said system including communication means whereby in the event one of said entities licences one or more of said licencable elements, said communication means automatically communicates to all others of said entities any restrictions incorporated in the licence conferred.
